(19) United States
(12) Patent Application Publication
(10) Pub. No.: US 2010/0311393 A1
(43) Pub. Date: Dec. 9, 2010

(54) METHODS AND APPARATUS FOR DISTRIBUTING, STORING, AND REPLAYING DIRECTIVES WITHIN A NETWORK

(76) Inventor: Mark Castleman, Austin, TX (US)

Correspondence Address: COOLEY LLP;ATTN: Patent Group, Suite 1100, 777 - 6th Street, NW, WASHINGTON, DC, 20001, US

(21) Appl. No.: 12/480,435

(22) Filed: Jun. 8, 2009

(51) Int. Cl. H04L 12/58

(52) U.S. Cl. 455/412.1

(57) ABSTRACT

In one embodiment, a processor-readable medium stored code representing instructions that when executed by a processor cause the processor to receive a directive from a first client device, store the directive at a memory location, and send the directive to a second client device. The directive includes a directive description portion and a directive content portion. The memory location is associated with the first client device. The directive is configured to cause the second client device to update a context of a display operatively coupled to the second client device in response to the directive. The context being of a directive class associated with the directive description portion, and having a value associated with the directive content portion.

### RELATED APPLICATIONS

This application is related to co-pending U.S. patent application bearing attorney docket no. SWAK-001/00US 311665-2002, filed on same date herewith, and entitled “METHODS AND APPARATUS FOR DISTRIBUTING, STORING, AND REPLAYING DIRECTIVES WITHIN A NETWORK,” co-pending U.S. patent application bearing attorney docket no. SWAK-001/01US 311665-2005, filed on same date herewith, and entitled “METHODS AND APPARATUS FOR DISTRIBUTING, STORING, AND REPLAYING DIRECTIVES WITHIN A NETWORK,” and co-pending U.S. patent application bearing attorney docket no. SWAK-001/02US 311665-2006, filed on same date herewith, and entitled “METHODS AND APPARATUS FOR DISTRIBUTING, STORING, AND REPLAYING DIRECTIVES WITHIN A NETWORK;” each of which is incorporated herein by reference in its entirety.

### BACKGROUND

One or more embodiments relate generally to distributing, storing, and replaying messages within a network, and, in particular, to methods and apparatus for distributing, storing, and/or replaying directives among communication devices within a network.

Communication between communication devices such as cellular phones, personal digital assistants, and other devices is complicated by many factors. Such communication devices, being portable, can be moved from one location to another without much thought or effort from the individuals using these communication devices. As these communication devices are moved, however, their connectivity to a network changes dynamically. For example, a cellular phone connects to a network through with various service towers as the cellular phone is moved from one place to another. At times, these communication devices are unavailable or inaccessible via the network for periods of time as they are moved from place to place. Such inaccessibility can result is missed communications.

Additionally, remotely manipulating data or resources such as a display or speaker of such communication device can be difficult because of platform dependencies of the communication devices. Thus, many incompatibilities arise between different communication device platforms.

### SUMMARY

In one embodiment, a processor-readable medium stored code representing instructions that when executed by a processor cause the processor to receive a directive from a first client device, store the directive at a memory location, and send the directive to a second client device. The directive includes a directive description portion and a directive content portion. The memory location is associated with the first client device. The directive is configured to cause the second client device to update a context of a display operatively coupled to the second client device in response to the directive. The context being of a directive class associated with the directive description portion, and having a value associated with the directive content portion.

### BRIEF DESCRIPTION OF THE DRAWINGS

FIG. 1 is a schematic diagram that illustrates communication devices in communication with a host device via a network, according to an embodiment.

FIG. 2 is an illustration of a directive including a directive description portion and a directive content portion, according to an embodiment.

FIG. 3 is an illustration of a portion of a memory storing a group of directives, according to an embodiment.

FIG. 4 is a flowchart that illustrates a method for defining and distributing a group of directives, according to an embodiment.

FIG. 5 is a schematic diagram that illustrates several images from a set of images selected and displayed at a display based on paths associated with directives, according to an embodiment.

FIG. 6 shows a schematic illustration of a display of a communication device displaying symbols that can be associated with a directive sent to and/or received from a remote device, according to another embodiment.

FIG. 7 is a flowchart that illustrates a method for initiating a communications session and distributing directives via the communications session, according to an embodiment.

FIG. 8 is a flowchart that illustrates a method for providing directives to a communication device via a communications session, according to an embodiment.

FIG. 9 is a flowchart that illustrates a method for initiating a unilateral communications session and distributing directives via the communications session, according to an embodiment.

FIG. 10 is a sequence diagram that illustrates a method for distributing a directive, according to an embodiment.

FIG. 11 is a sequence diagram that illustrates another method for distributing a directive, according to an embodiment.

### DETAILED DESCRIPTION

One or more embodiments can be capable of distributing directives among a group of communication devices. The directives can be distributed in real-time (e.g., directives can be sent serially as the directives are produced locally and received remotely and serially at the same or substantially the same rate) and/or stored for later distribution. For example, a computer server can be configured to initiate, at the request of a communication device via a network, a communications session, and that communication device can communicate (e.g., send and receive directives) with other communication devices via the communications session.

In some embodiments, a communications session can include a process, application, and/or software module that is configured to communicate with a group of communication devices (e.g., cellular phones, personal digital assistants, desktop computers, and/or notebook or laptop computers) such that the communication devices can send directives to and receive directives from one another via the communications session. In other words, the communications session can function as a relay for directives. Said differently, communication devices can send a directive via the communications session, and the directive can be forwarded to the one or more other communication devices via the communications session. In some embodiments, a communications session can be implemented or hosted at a host device such as a processor and/or other hardware module.

In some embodiments, a group of communication devices can be invited to participate in or be associated with a communication session. For example, after a communication session is initiated, invitations can be sent via the communications session to the group of communication devices to join the communications session. Communication devices can respond to the invitation to join or associate with the communications session. Communication devices that have joined the communications session can receive directives from one or more other communication devices via the communications session. In some embodiments, communication devices that have joined the communications session can send directives to one or more other communication devices via the communications session.

In some embodiments, a communications session can store (or record or archive) the directives that are distributed among the communication devices before the directives are forwarded (or sent) from the communications session. Thus, after a communications session has completed or is closed, a communication device can access a recording or archive of the communications session (e.g., the directive distributed via the communications session) to request or retrieve the directives of the communications session.

In some embodiments, a communications session can be agnostic to the type or types of directives that are distributed among communication devices associated with the communication session. In other words, a communications session can operate or function independent of the type or types of content (or data) that are included in the directives. Said differently, multiple types of data (or content) can be distributed through a single communications session. For example, video data, audio data, image data, textual data, operational instructions, and/or control commands can be distributed via a single communications session. Furthermore, multiple types (or classes) of directives associated with a communications session can be stored in a common format such that the types of directives are not differentiated.

In some embodiments, a directive can include a directive description portion and a directive content portion. The directive description portion can include a directive type (or class) identifier or indicator. The directive content portion can include a data set that is described or identified by the directive description portion. For example, a directive can include a directive content portion that includes audio data that is encoded, for example, as hexadecimal digits. The directive can also include a directive description portion that includes an identifier such as, for example, an integer value or a textual description of the directive content portion of the directive such as, for example, “hexadecimal-encoded audio data.” Thus, the communication device that receives the directive can determine how to process, interpret, and/or parse a directive content portion of that directive based on a directive description portion of that directive. Moreover, because directives are self-describing (e.g., a directive includes a description or identifier of the data or contents of that directive), in some embodiments the communications session (or the server or host device at which the communications session is instantiated or is running) while open can process different classes or types of directives in an identical manner, deferring directive class-specific or special processing to the communication devices. Said differently, the communications session can be agnostic to or function without determining directive classes of directives that pass through a server hosting the communications session.

As used in this specification, the singular forms “a,” “an” and “the” include plural referents unless the context clearly dictates otherwise. Thus, for example, the term “a communication device” is intended to mean a single communication device or multiple communication devices; and “network” is intended to mean one or more networks, or a combination thereof.

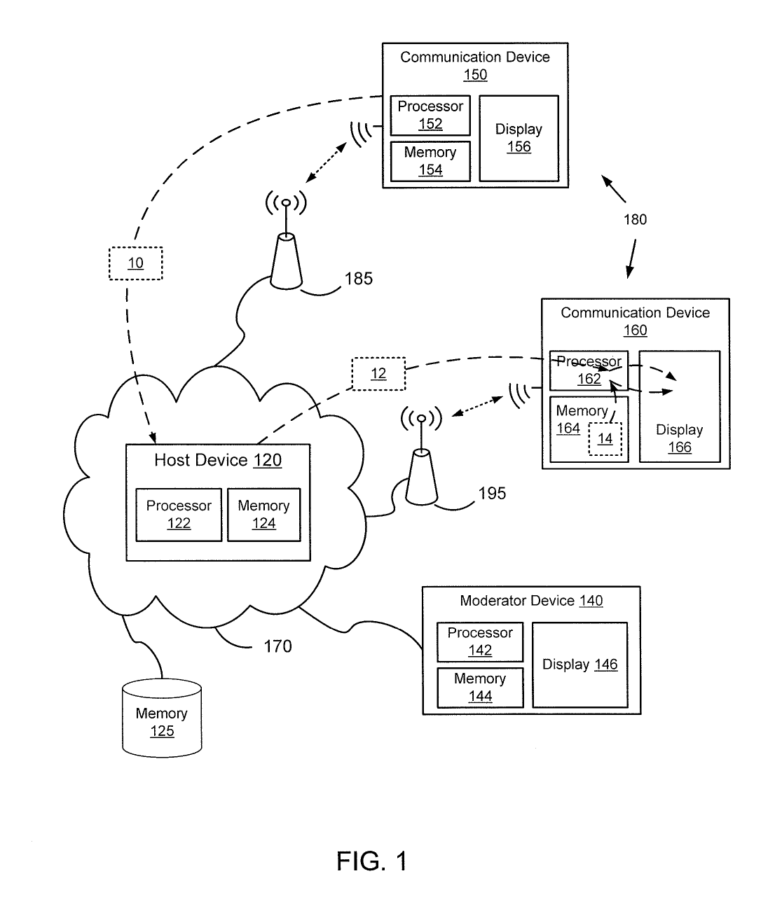

FIG. 1 is a schematic diagram that illustrates communication devices 180 in communication with a host device 120 via a network 170, according to an embodiment. Specifically, communication device 150 is configured to communicate wirelessly with the host device 120 via a gateway device 185. Similarly, communication device 160 is configured to communicate wirelessly with the host device 120 via a gateway device 195. The network 170 can be any type of network (e.g., a local area network (“LAN”), a wide area network (“WAN”), a virtual network, a telecommunications network) implemented as a wired network and/or wireless network with one or more segments in a variety of environments such as, for example, an office complex. In some embodiments, network 170 can be a combination of one or more homogeneous or heterogeneous networks.

Host device 120 can be any type of device configured to send data over the network 170 to and/or receive data from one or more of the communication devices 180. In some embodiments, the host device 120 can be configured to function as, for example, a server device (e.g., a web server device), a network management device, and/or so forth. In some embodiments, host device 120 can be configured to host a communications session.

A communications session can be a connection or relationship such as, for example, a logical connection, a virtual connection, or physical connection between one or more communication devices and a communications session controller. Individual connections (e.g., logical, virtual, or physical) between a single communication device and a communications session controller can be referred to as communications session links. A communications session can include the communications session controller and the communications session links between communication devices and the communications session controller. Thus, communication devices can communicate (e.g., send directives to) one with another via the communications session by passing or relaying that communication through a communications session controller hosted at a host device via communications session links. In other words, each communication device can send directives to the communications session controller via communication session links, and the communications session controller can distribute those directives to the other communication devices connected to (or associated with) the communications session via other communications session links. This process can be referred to as communicating (e.g., sending and receiving directives) via the communications session.

A communications session controller can function as a hub or central relay for distribution of directives among communication devices that are associated with a communications session. Communication devices can associate with or join a communications session by establishing a communications session link with a communications session controller, and can send directives to and receive directives from other communication devices that are also connected to the communications session via the communications session. For example, it is generally difficult for two communication devices that are behind separate network address translation (“NAT”) appliances to communicate one with another. Each communication device, however, can separately connect to a communications session controller, which is generally not behind a NAT appliance, and communicate via or through the communications session. In other words, the communication devices can each send directives to the communications session controller via a communications session link, and can receive directives from the communications session controller via that or another communications session link. In addition to providing connectivity or communication between two communication devices, a communications session can provide connectivity among many communication devices connected to or associated with the communications session. Furthermore, in some embodiments, one platform or type of communication devices can send directives to a communications session controller in a common format, and the communications session controller can distribute the directives to communication devices of another platform in another format that is compatible with that platform. In other words, communication devices of various platforms that cannot natively communicate one with another can communicate one with another via the communications session.

A communications session controller can be implemented as software (e.g., source code, object code, one or more scripts, or instructions) stored at a memory and operable to be executed and/or interpreted or compiled at a processor operatively coupled to the memory. In other words, a communications session controller can be hosted at a host device such as a server, and a server can host multiple communications session controller simultaneously. For example, a communications session controller can be an application (or an instance of an application) hosted at host device 120 illustrated in FIG. 1.

Because a communications session controller can be hosted at a host device, interaction with that communications session controller (e.g., sending directives to or via and received from or via a communications session) can be discussed as interaction with the communications session controller itself, or as interaction with the host device at which the communications session controller is hosted. For example, a directive can be discussed as being sent to the communications session controller, or can be discussed as being sent to the host device.

Alternatively, the directive can be discussed as being sent to one or more communication devices via the communications session. Such expressions are generally interchangeable. In other words, a directive sent via a communications session can be sent to the host device at which processing associated with the communications session (e.g., storing or sending to a moderator) can be completed (e.g., by a communications session controller software module) before the directive is forwarded to one or more communication devices by a communications session controller.

Similarly, for example, a directive can be discussed as being stored by a host device or by a communications session controller (e.g., an instance of a software module hosted at the host device). Said differently, a host device can include the physical hardware that effects processing (e.g., sending, receiving, interpreting, storing, etc.) of directives, and the communications session controller can provide control signal that trigger or effect such processing.

In some embodiments, each communications session controller hosted at a host device can be a separate or distinct application, software module, or instance of the same at the host device associated with a single communications session. In other words, a separate communications session controller (e.g., a process) can exist at a processor of a host device for each communications session at that host device. In some embodiments, a communications session controller can include a communication module (e.g., a network interface a network interface stack and/or a software module) and multiple processing or interpretation modules. The communication module can determine based on, for example, a directive description portion of a directive a processing or interpretation module to which the directive should be provided for processing. In other words, the communication module can determine which processing module is configured to process a particular directive class. For example, a communications module can send directives including video data to one processing module, and directives including representations of glyphs to another processing module. The communications session controller can provide an output signal based on the processing at one or more processing modules.

In some embodiments, a single application, software module, or instance of the same at a host device can process directives of or related to multiple communications sessions. For example, directives can include a communications session identifier which is used by a process at a processor of the host device to determine with which communications session that directive is related. Based on the communications session identifier, the host device (or the process at the host device) can determine, for example, to which communication devices the directive should be forwarded, whether the directive should be sent to a moderator, and/or other processing.

Thus, a communications session can include, for example, communications session controller that is an instance of a software module at a host device, and/or a collection of directives collectively associated with a communications session identifier. Similarly, multiple communications session controllers can be associated with a communications session to collectively or in parallel process (e.g., receive, store, send, etc.) directives that are sent via that communications session.

In some embodiments a communications session controller can be implemented as one or more hardware modules such as, for example, an application specific integrated circuit (“ASIC”), a field-programmable gate array (“FPGA”), a processor, or other hardware device. In some embodiments, a communications session controller can be implemented at both a hardware module and a software module. In some embodiments, such a module can be referred to as a communications session module (or communications session controller module). Additionally, in some embodiments, a communications session (or a communications session controller) includes one or more portions of one or more memories for storing directives. For example, a communications session controller can be associated with a portion of a local random-access memory (“RAM”) and a portion of a remote database such that directives can be stored within the communications session controller locally at the RAM and remotely at the database. For example, memory 125 illustrated in FIG. 1 can be configured as a database, and a communications session controller hosted at host device 120 can store directive at memory 125. In some embodiments, a communications session controller can use a portion of a local RAM as a memory cache for a remote database.

Communications sessions can be opened or initiated by communication devices 180 (e.g., a communication device can send a communications session initiation request to a server configured to host communications session), and other communication devices can be invited or authorized to join the communications session. After the communication devices have joined the communications session, the communication devices can send directives to and receive directives from one another via the communications session. In other words, the communication devices can send directives to a communications session controller, and the communications session controller can forward or distribute those directives via the communications session links of the communications session. Said differently, the communication devices can send directives to the host device hosting the communications session controller via the communications session links, and the host device can forward or distribute those directives via the communications session links. In some embodiments, directives can be broadcast to all communication devices associated with (or that have joined) the communications session. In some embodiments, directives can be addressed to a particular communication device or group of communication devices that have joined the communications session. When the communication devices have completed communicating via the communications session, the communications session can be closed.

In some embodiments, a communications session controller can store or record the directives that are distributed through the communications session. In other words, the communications session controller can produce an archive of the individual directives that are distributed via the communications session. Thus, a communication device can access directives distributed via a communications session (e.g., while the communications session was open or active) after the communications session has closed (or is inactive) to receive or access those directives. Additionally, a communication device can access a history of directives that have been distributed by a currently open (or active) communications session. Said differently, a communications session controller can include an archive of the activity (e.g., the directives distributed) within or via that communications session.

Communications sessions can include properties, characteristics, parameters, and/or rules that define or describe how communication devices connect to a communications session, which directive classes can be distributed by a communications session, what level of permissions are required to join or initiate a communications session, security options and/or requirements of a communications session (e.g., type and/or strength of encryption used within a communications session), and/or other characteristics. In some embodiments, a communications session can be monitored or observed by a moderator such as a communication device referred to as a moderator device. The communications session controller can request approval or authorization from the moderator before performing certain actions. For example, the communications session controller can send a request for authorization to initiate and/or close the communications session. Additionally, the communications session controller can send a request for authorization to distribute directives of certain directive classes.

In some embodiments, a communications session controller can store directives in a local memory while the communications session is open or active, and archive the directives to another (possibly remote) memory such as a database, network attached storage (“NAS”) device or some other archive memory. In some embodiments, a communications session controller stores directives locally and at an archive memory during operation of the communications session (e.g., while the communications session is active). In some embodiments, a local memory can be a volatile memory such as a RAM, and an archive memory can be a non-volatile memory such as, for example, a magnetic disk or a FLASH or other solid-state memory. In some embodiments, a host device can receive a request for access to the directives of a closed communications session from a communication device, and the host device can provide the directives of that communications session (e.g., archived directives) to that communications device.

In some embodiments, a communications session can be related to a canvas that is accessible to communication device associated with the communications session. In other words, the directives distributed within a communications session can be relative to a canvas. A canvas can be a virtual workspace, a desktop and/or a background represented in a memory of a communication device or a host device (or a communications session controller hosted at the host device). In some embodiments, a canvas can be represented across multiple devices. For example, a first portion of a canvas can be displayed on a first communication device and a second portion of the canvas can be displayed on a second communication device. In other words, various portions of the canvas can be represented within memories of various communication devices and/or a communications session controller. In some embodiments, the canvas includes access properties that can indicate which users and/or communication devices can access which portions of the canvas. For example, a first user might be authorized to access the first portion of the canvas, but not the second portion of the canvas.

In some embodiments, a canvas has display properties that indicate how the canvas is to be displayed on a first device and/or a second device. In some embodiments, the canvas has size properties indicating dimensions of the canvas (e.g., height, width, depth, etc.).

Additionally, a canvas can define a coordinate system or space within which symbols, images, glyphs, video data, and/or other display objects are positioned. In some embodiments, for example, the coordinate system can be absolute such that a symbol displayed in a first portion of the canvas has the same coordinates relative to a first communication device and a second communication device. In other embodiments, the coordinate system can be relative to the communication devices viewing the canvas. In some embodiments, an entire canvas can be represented at a display operatively coupled to a communication device. In some embodiments, a canvas can be spread across multiple devices. In other words, one portion of a canvas can be displayed at a display operatively coupled to once communication device, and another portion of that canvas can be displayed at a display operatively coupled to another communication device. In some embodiments, a communication device can zoom and/or pan a context of the display (or a view of the canvas displayed at the display) such that various perspective views and/or portions of the canvas can be displayed at a display operatively coupled to that communication device.

Referring now to FIG. 1, in some embodiments, each of the communication devices 180 can be, for example, a computing entity (e.g., a personal computing device), a mobile phone, a monitoring device, a personal digital assistant (“PDA”), other mobile communication devices (such as smart phones or other portable communication devices with relatively low-power processing and graphics functionalities), and/or so forth. In some embodiments, communication devices can also be referred to as client devices. For example, communication device 180 can be referred to as client devices with respect to host device 120. Although not shown, in some embodiments, each of the communication devices 180 can have one or more network interface devices (e.g., a network interface card). In some embodiments, each of the communication devices 180 can function as a source device and/or as a destination device. Although shown as wireless communication devices in FIG. 1, in some embodiments, one or more of the communication devices 180 can be configured to communicate over the network 170 via a wire, or alternatively can be a wired communication device without wireless communication capabilities.

As shown in FIG. 1, the processor 162 of the communication device 160 is configured to receive a directive 12 from host device 120 (or a communications session controller hosted at host device 120). In some embodiments, the processor 162 can be configured to select an image from the set of images 14 and/or trigger display of the image at a target location and/or with a specified timing based on one or more portions of the directive 12. For example, the processor 162 can be configured to select an image for display along a path defined within the display 166 of the communication device 160 during a specified time period based on the directive 12. In some embodiments, the directive 12 can be configured to trigger processing of (e.g., rendering of, display of) a media resource such as a visual resource (e.g., a glyph) and/or an audio resource. For example, in some embodiments, the directive 12 can include compressed sensor data that can be used to trigger display of a glyph (e.g., an alphanumeric letter, an outline of a shape).

Similar to communication device 160, the communication device 150 has a processor 152, a memory 154, and a display 156. As shown in FIG. 1, the communication device 160 can be configured to define a directive 10 that can be sent to host device 120. The directive 10 can be defined at the communication device 150 in response to a interaction of a user with the communication device 150. For example, in some embodiments, the directive 10 can include compressed sensor data produced based on an interaction of a user with the display 156 or other type of user interface (not shown) associated with (e.g., included in) the communication device 150. In some embodiments, communication device 150 can be configured to perform a function associated with communication device 160, and vice versa.

In some embodiments, the directive 12 can be associated with the directive 10. For example, in some embodiments, the directive 12 can be a copy of the directive 10. In other words, the directive 10 can be pushed to the host device 120 from communication device 150, copied at the host device 120, and forwarded from the host device 120 to the communication device 160 as directive 12. In some embodiments, the directive 12 can be defined at a processor 122 of the host device 120 based on the directive 10. For example, the directive 12 can have a data portion (e.g., a payload portion) equal to directive 10, but directive 12 can have routing portion that is different than a routing portion included in directive 10.

In some embodiments, the directive 12 and/or directive 10 can be stored at a memory 124 of the host device 120. For example, the directive 12 can be stored at the host device 120 until the directive 12 is requested by communication device 160. In response to the request, the directive 12 can be sent to the communication device 160. In some embodiments, the directive 10 can be stored at the memory 124 of the host device 120 until a request for a directive is received from the communication device 160. In response to the request, the host device 120 can be configured to define directive 12 based on directive 10 and can send directive 12 to the communication device 160. In other words, the directive 12 can be pulled from the host device 120 by the communication device 160.

In some embodiments, one or more portions of the host device 120 (e.g., the virtual switch module 110) and/or one or more portions of the communication devices 180 can include a hardware-based module (e.g., a digital signal processor (“DSP”), an FPGA) and/or a software-based module (e.g., a module of computer code, a set of processor-readable instructions that can be executed at a processor).

In some embodiments, one or more of the functions associated with the host device 120 (e.g., the functions associated with the processor 122) can be included in one or more modules. In some embodiments, one or more of the functions associated with the communication devices 180 (e.g., functions associated with processor 152) can be included in one or more modules. In some embodiments, communication device 150 can be configured to perform one or more functions associated with communication device 160, and vice versa. In some embodiments, one or more of the communication devices 180 can be configured to perform one or more functions associated with the host device 120, and vice versa.

For example, in some embodiments, communication devices can distribute directives among one another in a peer-to-peer or ad-hoc configuration. For example, communication devices can form an ad-hoc network without a host device if a host device is inaccessible via a network to which the communication devices are operatively coupled. In some embodiments, one communication device can be configured to function as a host device (e.g., to host a communications session controller), and the other communication devices can interact with that communication device as though that communication device is a host device. In some embodiments, a communication device hosting a communications session controller can store some, but less than all of the directives distributed within that communications session. For example, directive of certain directive classes or those that are addressed to or from particular communication devices can be stored and other directives can not be stored. In some embodiments, the stored directives and any other parameters of the peer-to-peer communications session can be uploaded to a host device when that host device is accessible (e.g., via a network). In some embodiments, no directives are stored in a peer-to-peer communications session controller. In some embodiments, a log of communication devices associated with the peer-to-peer communications session can be uploaded to a host device when that host device is accessible (e.g., via a network).

In some embodiments, communication devices can operate as true peers within a peer-to-peer communications session. In other words, each communication device can function as a partial host device. Said differently, each communication device can forward directives to other communication devices. In some embodiments, each communication device can store directives that it receives and/or sends, and those directives (and communications session parameters such as an identifier of the communications session) can be uploaded to a host device when that host device is accessible (e.g., via a network).

As illustrated in FIG. 1, moderator device 140 can also be operatively coupled to network 170. Moderator device 140 can be operatively coupled to network 170 via a wired or wireless network interface, and can be associated with a communications session controller hosted at host device 120. Moderator device 140 includes processor 142, memory 144, and display 146, and is similar in function to communication devices 180. For example, moderator device 140 can be a communication device delegated or assigned to monitor a communications session. In other words, the directives received at a communications session controller hosted at host device 120 can be forwarded to moderator device for preview and/or authorization. Moderator device 140 can react to or process directives similarly to communication device 180 such that a preview of directives at moderator device 140 is an accurate preview of the effect of a directive at one or more of communication devices 180.

In some embodiments, moderator device 140 can have full permissions to access stored directives of communications sessions (e.g., directives stored during a communications session) such that moderator device 140 can request access to those directives and receive a transcript (e.g., the directives) of the communications session. In some embodiments, moderator device 140 can access a history of an active or open communications session (e.g., the directives distributed via a communications session). In some embodiments, moderator device 140 can delete or remove directives from a memory associated with a communications session controller even after they are stored in an archive memory and the related communications session is closed. In some embodiments, other communication device (e.g., communication devices 180) can access a transcript or history of a communications session.

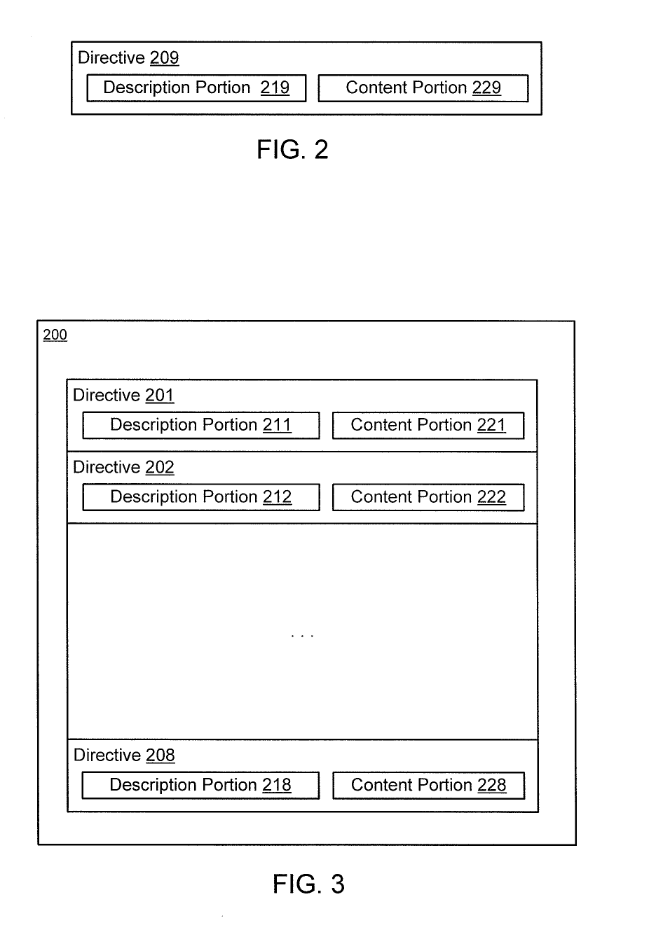

FIG. 2 is an illustration of a directive including a directive description portion and a directive content portion, according to an embodiment. Directive 209 includes directive description portion 219 and directive data portion 229. In some embodiments, directive 209 can include additional portions such as, for example, a length or size portion including a length (e.g., in bytes or bits) of directive 209. Directive description portion 219 can include an identifier or other indicator of a type or class of directive 209. In other words, directive description portion 219 can include a directive class or type identifier. In some embodiments, directive description portion 219 can describe or provide an indication of the contents or format of directive content portion 229. For example, directive description portion 219 can indicate that directive content portion 229 includes one or more of, for example, video data, audio data, image data, textual data, numeric data (e.g., one or more groups of bits representing signed integer values, one or more groups of bits representing unsigned integer values, and/or one or more groups of bits representing floating-point values), operational instructions, and/or control commands. In some embodiments, a directive can include extensible markup language (“XML”) data and/or extensible messaging and presence protocol (“XMPP”) data.

A communication device or a communications session controller can access or read directive description portion 219, to determine how to process or interpret directive 209 or a portion of directive 209 such as directive data portion 229. For example, a communications module can determine how to parse a binary bit string or sequence included in directive content portion 229 based on a directive class identifier included in directive description portion 219. In some embodiments, directive content portion 229 can include encoded data such as, for example, hexadecimal-encoded data or base64-encoded data. A directive class identifier included in directive description portion 219 can provide an indication to, for example, a communication device of the encoding scheme (or schemes) with which the data included in directive content portion 229 is encoded (e.g., a hexadecimal-encoding data scheme or a base64-encoding scheme). In some embodiments, directive content portion 229 can include data representing instructions or commands to be executed by a communication device that receives directive 209. Such instructions or commands can include parameters, characteristics, and/or arguments that can be interpreted or used by a communication device during execution of one or more instructions or commands, and can be referred to as directive parameters or characteristics.

For example, directive content portion 229 can include drawing instructions generated, for example, in response to user input at a first communication device. The drawing instructions can include parameters (e.g., characteristics, arguments and/or representations of glyphs) such as, for example, lines, arcs, geometric figures (e.g., circles, ellipses, and/or polygons), paths, and/or groups of points. A communication device receiving directive 209 can determine how to interpret (or process) the drawing instructions and/or parameters based on directive description portion 219, and draw one or more glyphs, images and/or symbols at a display operatively coupled to that communication device based on the drawing instructions and parameters. Said differently, a display module of a communication device receiving directive 209 can trace or display lines, arcs, paths, geometric figures, and/or points defined within a drawing instruction at a display of that communication device. In other words, a communication device receiving directive 209 can reproduce a symbol such as an image, a glyph, and or collections of the same. that is described by one or more drawing instructions included in directive description portion 229.

In some embodiments, a drawing instruction can include additional parameters such as, for example, line, arc, path, geometric figure, and/or point weights and/or colors, drawing speed or velocity (e.g., a rate at which lines, arcs, paths, geometric figures, and/or points are drawn or displayed to a display operatively coupled to a communication device receiving directive 209), times (e.g., a time period within which lines, arcs, paths, geometric figures, and/or points are drawn or displayed to a display operatively coupled to a communication device receiving directive 209), and/or directionalities (e.g., in which direction to paint or trace a line). In some embodiments, a communication device can include user drawing preferences configured to function as defaults for drawing parameters or instructions that are not included in (or to override) directive content portion 229. For example, a directive class identified by directive description portion 219 can include a drawing instruction that defines a line, but does not define a line weight or color as a parameter. One or more user drawing preferences at a communication device receiving directive 209 can be used by, for example, a display module of that communication device to determine or select a line weight and/or color for the line defined within the drawing instruction of directive content portion 229.

In some embodiments, directive content portion 229 can include image data and/or position and/or orientation data related to one or more images. For example, directive content portion 229 can include a group of base64-encoded images, position information or instructions, and orientation information or instructions for those images. In other words, a communication device can receive directive 209, determine the contents of directive 209 based on a directive class identifier included in directive description portion 219, and display images included in directive content portion 229 at display positions defined (or described) by position parameters of directive description portion 229 and in orientations (e.g., rotational offsets) defined (or described) by orientation parameters of directive description portion 229. In some embodiments, directive content portion 229 can include position and orientation information and/or identifiers of pre-loaded images. The pre-loaded images can be displayed based on the orientation and/or position information in directive portion 229.

In some embodiments, directive 209 can include multiple directive content portions. For example, directive 209 can include images as hexadecimal-encoded image data within directive content portion 229, and position parameters, orientation parameters, and/or other parameters related to those images within another directive content portion. In some embodiments, directives can be complimentary. For example, directive 209 can include images as binary image data (e.g., within directive content portion 229), and another directive can include position parameters, orientation parameters, and/or other parameters related to the images included in directive 209.

In some embodiments, directive 209 can include multiple directive description portions and multiple directive content portions. For example, each directive content portion can related to a directive description portion of a directive. In some embodiments, a single directive description portion can define or describe multiple directive content portions. Similarly, in some embodiments multiple directive description portions can define or describe a single directive content portion.

FIG. 3 is an illustration of a portion of a memory storing a group of directives, according to an embodiment. Memory 200 stores directive 201, directive 202 through directive 208. As discussed above, directives 201, 202 through 208 include directive description portion 211, directive description portion 212 and directive description portion 218, respectively, and directive content portion 221, directive content portion 222 and directive content portion 228, respectively. Memory 200 can be, for example, a database or other archive memory, or a RAM configured as a transmission buffer of a communications module within a communication device, or at a host device hosting a communications session controller.

As illustrated in FIG. 3, directives 201, 202 through 208 can be stored in a common format within memory 200. In some embodiments, directives 201, 202 through 208 are of different directive classes (or types), and are stored within memory 200 in a common format. In other words, that manner in which directives 201, 202 through 208 are stored at memory 200 is not dependent on the directive class of any of directives 201, 202 through 208. Said differently, each directive 201, 202 through 208 is stored at memory 200 as a generic directive rather than as a directive of a particular directive class. For example, directive 201 can include audio data within directive content portion 221, directive 202 can include drawing instructions within directive content portion 222, and directive 208 can include numeric data within directive content portion 228. Each of directives 201, 202 through 208 can be stored at a common portion of memory 200 in a common format such that the directive class of any of directives 201, 202 through 208 cannot be determined based on the manner or format in which directives 201, 202 through 208 are stored at memory 200. Because directives 201, 202 through 208 are stored in a common format (e.g., stored generically as directives), a host device such as host device 120 discussed above in relation to FIG. 1, can process each of directives 201, 202 through 208 in a common processing module. For example, a host device can receive, store, and forward each of directives 201, 202 through 208 using a common hardware module without interpreting any of directive description portions 211, 212 through 218.

In some embodiments, directives of different directive classes can be processed differently. For example, a directive class can describe directives that include high-priority video data such as video conferencing data within a directive content portion. Because such data is time-sensitive (e.g., additional latency in delivery of the data to a destination can greatly degrade performance and user perception of the video conferencing experience), a host device can prioritize directives of this directive class. For example, such directives can be stored at a memory with a data-write speed or rate that is faster than a data-write speed or rate of a memory at which directives of directive classes describing directives that include less time-sensitive data (e.g., those describing directives including low-priority textual data within a directive content portion) are stored. Similarly, such directives can be prioritized in a transmission buffer (e.g., queue) operatively coupled to a communications module within a host device such that these directives are transmitted (or forwarded) before directives of less time-sensitive directive classes. Furthermore, directives of directive classes that describe directives that include long-term storage data in a directive content portion can be stored at a memory with a higher reliability than a reliability of a memory at which directives of directive classes describing directives that include less important data are stored.

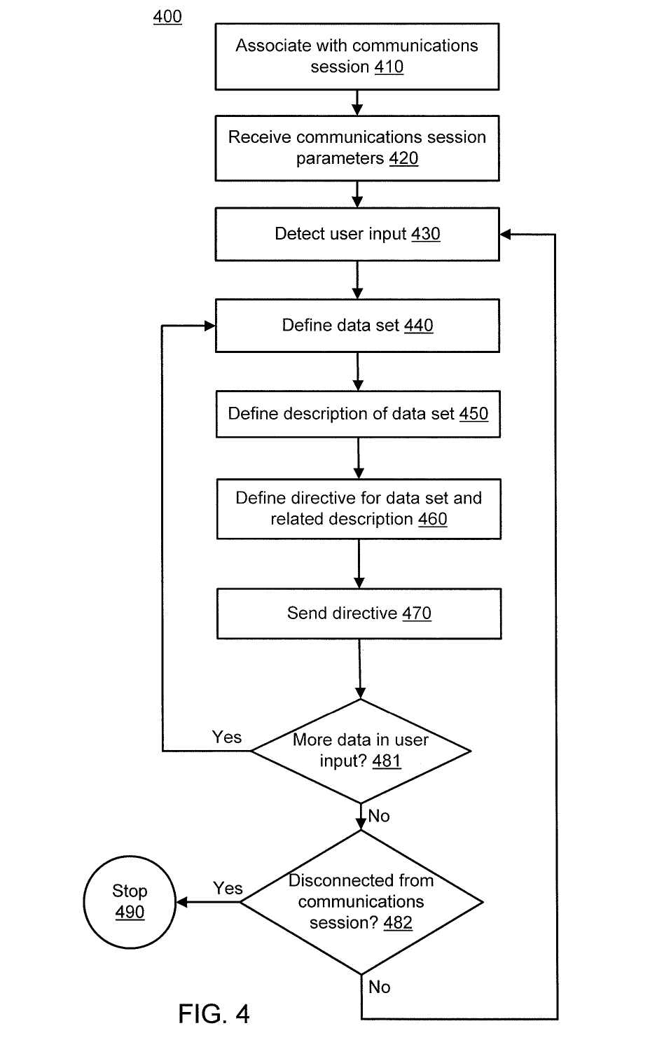

FIG. 4 is a flowchart that illustrates method 400 for defining and distributing a group of directives, according to an embodiment. Method 400 can be implemented, for example, as a software module (e.g., source code, object code, one or more scripts, or instructions) stored at a memory and operable to be executed and/or interpreted or compiled at a processor operatively coupled to the memory at a communication device. For example, processor-executable instructions stored at a memory of a communication device can be executed at a processor at the communication device to cause the processor to execute the steps of method 400. In some embodiments, method 400 can be implemented as one or more hardware modules such as, for example, an ASIC, an FPGA, a processor, or other hardware module at a communication device. In some embodiments, method 400 can be implemented as a combination of one or more hardware modules and software modules at a communication device.

A communication device can associate with a communications session, at 410. For example, the communication device can respond to an invitation to join or associate with a communications session (e.g., a communications session invitation). In some embodiments, a communication device can send an authentication request (e.g., a communications session authentication request) to a host device or a communications session hosted at the host device to associate with a communications session. In some embodiments, an authentication request can include authentication or authorization information. For example, an authentication request can include a credential (or access or authentication credential) such as a password, authentication challenge response, an encrypted message (such as an encrypted unique identifier of the communication device or a user of the communication device), a digital digest or hash, a digital certificate, and/or unique identifier. The host device can authenticate the communication device (or user of the communication device) with the communications session based on the credential. In other words, the host device can determine that the communication device (or the user of the communication device) is authentic (e.g., the entity it claims to be) and/or that the communication device (or the user of the communication device) is authorized to access the communication device based on the credential.

For example, a credential can be a unique identifier of a user of the communication device that is encrypted with a private key associated with that user. The host device can decrypt the unique identifier with a public key corresponding to the private key with which the unique identifier was encrypted to determine that the user of the communication device is authentic. Additionally, the host device can access a list of unique identifiers that are authorized to access the communications session. If the unique identifier included in the credential is included in the list, the host device can determine that the user of the communication device is authorized to access the communications session. In some embodiments, a unique identifier (e.g., a unique identifier of a user) can be related to or associated with a communication device. For example, the unique identifier can be a hardware identifier or address, or a network identifier or address of a communication device.

The communication device can receive parameters of the communications session, at 420. A communications session can include various parameters to, for example, define characteristics and/or data formats or values that are valid within that communications session. For example, a particular communications session can be related to transmission of textual data, and a parameter of communications session can define encoding (e.g., UTF-8, UTF-16 or UTF-32) of textual data that is transmitted via the communications session. In some embodiments, communications session parameters can be transmitted within directives of a parameter directive class. In some embodiments, parameters of a communications session can define other aspects or properties of a communications session such as, for example, which participants of the communications session (e.g., communication devices that are associated with the communications session) can send directives (e.g., to other communication devices associated with the communications session) via the communications session, and which participants of the communications session (also referred to as “participants”) can receive directives.

In some embodiments, one or more parameters of a communications session can describe or define which directive classes are valid within the communications session. In other words, a communications session can impose limits on which directive classes are distributed via the communications session, and/or which directive classes client applications or programs executing at a communication device can support (e.g., process and/or interpret) to be compliant or compatible with that communications session. In some embodiments, a communications session can disassociate from or leave a communications session if the communication device does not support or comply with one or more communications session parameters. In some embodiments, a communications session controller can disconnect from or disassociate with communication devices that do not comply with one or more parameters of that communications session. In some embodiments, parameters of a communications session can be negotiated between communication devices and the communications session controller. For example, parameters can be negotiated to determine which parameters are compatible with a majority of the communication devices, or which parameters (e.g., security parameters) offer the most secure communications session without violating minimum security standards or requirements. In some embodiments, a communication device can partition or configure itself (or one or more client applications related to the communications session) in response to the communications session parameters received, at 420.

After the communication device has received communications session parameters, at 420, and/or provisioned or configured the communication device in response to the communications session parameters, user input can be detected, at 430. For example, a communication device can include a user input device such as a touch screen and/or other user input devices such as a mouse, a camera, a microphone, an accelerometer, and/or a global positioning system (“GPS”) module configured to generate sensor data in response to user interaction with the user input device. The communication device (or a user interface or input module of or operatively coupled to the communication device) can detect contact points, gestures, or movement of the user with respect to the user input device using, for example, sensors operatively coupled to the user input device to generate the sensor data. In some embodiments, the sensor data can be generated by motion, objects, and/or other input detected by a camera, by movement of the communication device (e.g., detected via one or more accelerometers, gyroscopes, inertial measurement units (“IMUs”), and/or GPS modules), aural or audio input detected by a microphone, and/or by other input. The communication device can then define a data set, at 440, based on at least a portion of the sensor data.

A data set can be, for example, a portion of sensor data detected at a user input device of the communication device. In some embodiments, the data set can be a portion of sensor data representing a gesture such as, for example, a line, arc or path of the gesture. In other words, the data set can include a start point and an end point of a line with respect to an absolute or relative coordinate system such as, for example, a display or a canvas. Additionally, the data set can include a start point, an end point, and a radius of an arc, and/or a series of points defining a path. Other examples of data sets include image sensor (or camera) data and/or movement (or motion) data. In some embodiments, a data set can be compressed via a compression algorithm to minimize the size or length of a directive and/or to maximize or improve throughput of the communications session or one or more communications session links of the communications session.

In some embodiments, one data set can include one type of data and another data set can include a different type of data. For example, one data set can include lines, arcs, points, and/or paths derived from a gesture input at a touch screen operatively coupled to the communication device, and another data set can include drawing rates (e.g., speed of a gesture) related to these lines, arcs, points, and/or paths. A communication device receiving directives including these data sets can reproduce the gesture (e.g., as one or more glyphs) at a display operatively coupled to that communication device in form as well as at the rate the gesture was made at the source communication device. In other words, the gesture can be reproduced serially one per gesture basis at the destination communication device at the same (or substantially the same) rate or speed and in the same (or substantially the same) form as at the source communication device.

In some embodiments, the user input detected at 430 can be used to select or provide an indication of a data set to be defined at 440. For example, a user can indicate an image file, a video file, an audio file, a symbol, a message, or an image resource to be included in one or more directives. In other words, the user can select, for example, a video file (or a portion thereof) that is to be included in a directive as a data set within a directive content portion of that directive, and distributed via a communications session. In some embodiments, the video file can be distributed across multiple directives (e.g., portions of the file are defined as data sets and transmitted in multiple directives).

After the data set has been defined, a description of the data set is defined, at 450. For example, an identifier or indication of a directive class representing the data set can be defined. The description of the data set can indicate, for example, a source of the data set, the type of data included in the data set, the format of data included in the data set, the number of data values in the data set, the length (e.g., in bytes or bits) of the data set, whether a data set is compressed and the type of compression, and/or other characteristics of the data set. In some embodiments, the description can identify a processing module (e.g., a software module, a general purpose processor, or an ASIC) or a configuration of a processing module that can process or interpret the data set.

The description and the data set can be included in a directive description portion and a directive content portion of a directive, respectively, at 460. In other words, a directive can be defined based on the description defined at 450 and the data set defined at 440. In some embodiments, other portions of the directive can also be populated or defined, at 460. For example, the length (e.g., in byte) of the directive can be calculated and included in a portion of the directive, and/or a source identifier such as a hardware or network identifier of the source communication device of the directive can be included in another portion of the directive.

The directive can then be sent (e.g., to a communications session controller of the communications session), at 470, and the communication device can determine, at 481, whether more data are included in the user input detected at 430. If there are more data in the user input (e.g., additional lines, arcs, paths, and/or points within sensor data representing a gesture detected at a touch screen), the communication device can return to step 440 and define another data set. In some embodiments, one data set can be associated with a description related to a first directive class, and another data set can be associated with a description related to a second directive class. In other words, directive of multiple directive classes can be defined in response to a single user input or form of user input. In some embodiments, a single directive class can describe a single user input. If there are no more data in the user input (or there is an end indication from the user), the communication device can determine, at 482, whether the communication device is disassociated (or disconnected) from the communications session. If the communication device is disassociated from the communications session, the communication device can stop (or end) method 400, at 490. If the communication device is not disassociated from the communications session (i.e., the communication device is still connected to or in communication with the communications session controller) at 482, the communication device can return to step 430 to detect additional user input.

In some embodiments, method 400 can include more or fewer steps than illustrated in FIG. 4. For example, method 400 can include initiating the communications session and or sending a disassociation signal to the communications session controller. Additionally, in some embodiments, steps of method 400 can be rearranged. As illustrated in FIG. 4, directives are defined and sent in real-time. In other words, directives are sent serially as they are defined at the communication device. For example, the first directive can be defined and sent before the user has provided input for the third directive. In some embodiments, the steps of method 400 can be rearranged, and multiple directives can be defined before any are sent. For example, directives representing all the user input detected at step 430 can be defined before any directives are sent. As another example, directives including an entire image file selected by user input from a user for distribution via the communications session can be defined before any of these directives are sent. In some such embodiments, all the directives that are defined based on the user input can be sent at substantially the same time (e.g., the directives can be loaded into a transmission buffer and sent serially to the communications session controller for distribution via the communications session controller).

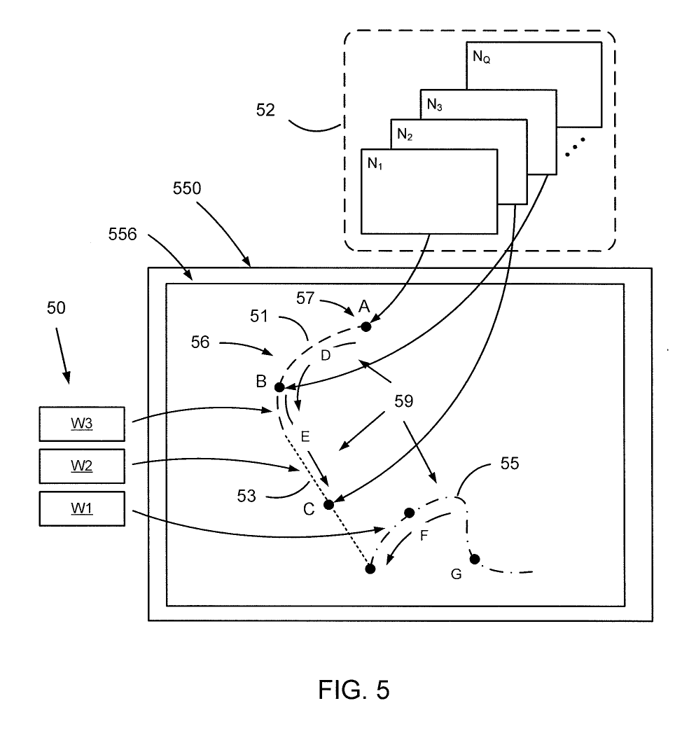

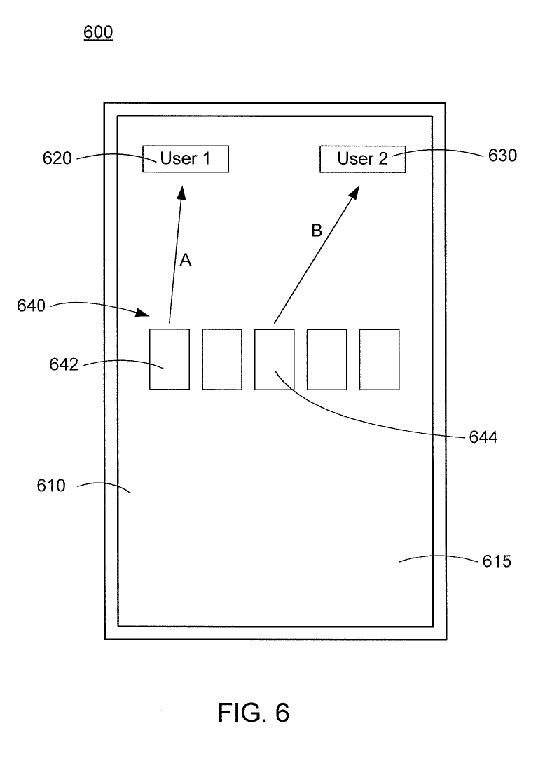

In some embodiments, directives can include (e.g., within a directive content portion) one or more instructions that cause a communication device receiving a directive to produce some output based on the directive. For example, a communication device can display a message or update a context (e.g., a portion) of a display in response to a directive. In some embodiments, a directive can include audio and/or video data and that data can be played at the communication device. In some embodiments, images can be manipulated and/or drawing at a display can occur in response to a directive. For example, FIG. 5 is a schematic diagram that illustrates several images from a set of images 52 (also referred to as an image resource) selected and displayed at a display 556 based on paths 59 associated with (or included within) directives 50, according to an embodiment. In some embodiments, an image resource includes orientation, sequence, and/or other metadata associated with a set of images. In some embodiments, the display 556 can be a display of communication device 550. Images from the set of images 52 can be selected and displayed at one or more target locations along one or more portions of paths 59. The paths 59 include path 51, path 53, and path 55. The set of images 52 includes images N₁ through N_{Q}, and the directives 50 include directive W1, directive W2, and directive W3.

As shown in FIG. 5, path 51 (shown as a dashed line) is defined based on directive W3, path 53 (shown as a dotted line) is defined based on directive W2, and path 55 (shown as a dash-dotted line) is defined based on directive W1. In some embodiments, a processor (not shown in FIG. 5) of a communication device 550 can be configured to interpret one or more portions of the directives 50, and can be configured to define the paths 59 within the display 556. For example, the directive W3 can include data (e.g., within a directive description portion and directive content portion) that can be used by a processor of the communication device 550 to define path 51, which has a curved portion 56, within the display 556. As shown in FIG. 5, path 53 is disposed between path 51 and path 55. Specifically, one end of path 53 is connected with path 51 and the other end of path 53 is connected with path 55. In some embodiments, the paths 59 shown in FIG. 5 may or may not be visible to a user of the communication device 550.

As shown in FIG. 5, image N₁ is selected and statically displayed at target location A on path 51, and image N₂ is selected and statically displayed at target location C on path 53. Image N₃ is selected and displayed starting at target location B on path 51. Image N₃ is moved along path 51 from target location B to target location C on path 53 along direction E. The image N₁, the image N₂, and the image N₃ can be displayed with a specified timing (e.g., starting a specified times and/or during specified time periods).

In this embodiment, images from the set of images 22 are serially displayed (e.g., serially displayed at mutually exclusive display start times, serially displayed during substantially mutually exclusive periods of times). In some embodiments, for example, image N₁ can be displayed immediately after display of image N₂ is completed, and image N₂ can be displayed immediately after display of image N₃ is completed. In some embodiments, one or more images from the set of images 22 can be displayed during overlapping periods of time (e.g., during overlapping periods of time that have mutually exclusive display start times).

Although the communication device 550 is configured to trigger display of several of the set of images 52 along at least portions of the paths 59, in some embodiments, the communication device 550 can be configured to trigger display of one or more of the images 52 at target locations that are not along the paths 59. For example, the communication device 550 can be configured to trigger display of one or more of the set of images a specified distance from a portion of one or more of the paths 59.

In some embodiments, images can be selected from the set of images 52 and/or displayed (e.g., displayed at target locations along (or a specified distance from) one or more portions of the paths 59, displayed at specified times (e.g., during specified time periods)) based on, for example, one or more parameter values associated with the portion(s) of the path(s) 59. The parameter value(s) can define one or more characteristics of portion(s) of the path(s) 59. In some embodiments, the parameter value(s) can be included in directives 50 associated with the portion(s) of the path(s) 59 and/or can be calculated at the communication device 550 based any data included in the directives 50 associated with the portion(s) of the path(s) 59. In some embodiments, the parameter value(s) can include a path curvature, a path width, a path length, a directionality (e.g., a set of vectors) of the path, a path velocity, a path orientation, a time period associated with the path (e.g., a time period that a portion of the path can be accessed), and/or so forth.

In some embodiments, the images from the set of images 52 can be selected and/or displayed at one or more target locations and/or at one or more specified times (e.g., during specified time periods) based on one or more rules (e.g., a set of rules) stored at the communication device 550. For example, one or more conditions within a rule can be satisfied (or unsatisfied) based on a parameter value associated with a path 59 (e.g., a characteristic of a path 59 as defined by a parameter value). One or more actions within the rule can be performed (e.g., executed) in response to the condition(s) being satisfied (or unsatisfied). In some embodiments, the rules can be associated with one or more applications or software modules installed at the communication device 550 and/or can be included in an algorithm that can be executed at the communication device 550.

In some embodiments, one or more rules can be included in a user preference that can be stored in a memory (not shown) of the communication device 550. In some embodiments, one or more rules can be defined in response to an interaction of a user with the communication device 550. For example, during display of one or more of the set of images 52 at the display 556 of the communication device 550, a user of the communication device can toggle a setting that modifies one or more rules used to select and/or display images from the set of images 52. Thus, selection and/or display of images from the set of images 52 can be changed in real-time. Specifically, selection and/or display of images from the set of images 52 before the setting is toggled can be performed based on a set of rules that is different than a set of rules used to perform selection and/or display of images from the set of images 52 after the setting has been toggled.

Specifically, the rules can be defined so that a specific type of motion is represented on the display 556. In some embodiments, images from a set of images 556 of an object can be selected and/or displayed on the display 556 in a specified order (e.g., a specified sequence) at specified target locations during specified time periods based on the rules to represent movement of the object within the display 556. For example, in some embodiments, rotational movement of an object around two non-parallel axes during a specified period of time can be represented within the display 556 in response to application of one or more rules at the communication device 550.

In some embodiments, for example, the communication device 550 can be configured to select one or more of the set of images 52 and/or display the image(s) (e.g., display at target locations along (or a specified distance from) one or more portions of the paths 59, display at specified times (e.g., during specified time periods)) based on the portion(s) of the path(s) 59 being in a particular location (as defined within a parameter value(s)). For example, the image N₁ can be selected and/or displayed at target location A at the end 57 of path 51 because the end 57 of path 51 is located within a specified area (not shown) within the display 556. The location of the end 57 of the path 51 within the specified area can be determined based on one or more parameter values included in directive W3. The parameter values included in directive W3 can be used at the communication device 550 to define the path 51 within display 556. In some embodiments, for example, the image N₂ can be selected and/or displayed at target location C because the path 53 has a specified portion within a particular quadrant or portion of the display 556.

In some embodiments, the communication device 550 can be configured to select one or more of the set of images 52 and/or display (e.g., display at a target location, display during a specified time period) the image(s) based on the portion(s) of the path(s) 59 having a specified shape (as defined within a parameter value(s) associated with the portion(s) of the path(s)). For example, the image N₂ can be selected and/or displayed at target location C because the path 53 is a straight line and/or because the path 53 has a length value longer than a specified threshold length value included, for example, as a part of a condition within a rule. In some embodiments, the shape of the path 53 can be defined within one or more parameter values associated with the path 53 (e.g., included in directive W2 used to define the path 53).

In some embodiments, for example, the image N₃ can be selected and/or displayed at target location B because path 51 has a specified curvature (or a curvature value greater than a threshold curvature value included as a part of a condition within a rule). In some alternative embodiments, an image other than N₃ could be selected and/or displayed at a different target location (not shown) than target location B if the path 51 had a different curvature than that shown in FIG. 5. For example, an image that has a specified orientation can be selected from a set of images based on a portion of a path having a concave portion (or convex portion) oriented in a specified fashion on a display. In other words, the image can be selected from a set of images so that the orientation of the image is based on the orientation of a curved portion of the path.

In some embodiments, a number of target locations at which images can be displayed can be determined based on a radius of curvature of a path. For example, in some alternative embodiments, more than two images could be selected by the communication device 250 for display along path 51 if the radius of curvature of path 51 were greater than that shown in FIG. 5. Similarly, in some alternative embodiments, less than two images could be selected for display by the communication device 550 along path 51 if the radius of curvature of path 51 were less than that shown in FIG. 5.

In some embodiments, the communication device 550 can be configured to select one or more of the set of images 52 and/or display (e.g., display at a target location, display during a specified time period) the image(s) based on the portion(s) of the path(s) 59 having a specified orientation (as defined within a parameter value(s) associated with the portion(s) of the path(s)). For example, the image N₂ can be selected and/or displayed at target location C because the path 53 is sloping in a particular direction within the display 556. Specifically, the slope of the path 53 can be determined by the communication device 550 based on a slope parameter value included in directive W2 (which is associated with path 53). The communication device 550 can be configured to trigger display of the image N₂ at target location C within display 556 because the slope parameter value satisfies a condition associated with a rule.

In some embodiments, the communication device 550 can be configured to select one or more of the set of images 52 and/or display (e.g., display at a target location, display during a specified time period) the image(s) based on one or more portions of the paths 59 having a specified orientation with respect to one or more portions of another of the paths 59. For example, the image N₂ can be selected and/or displayed at target location C because the path 53 is sloping towards path 55 and/or because the path 53 is sloping away from an end of path 51. The relationship between path 53 and path 51 can be determined based on one or more parameter values included in directive W2 and directive W3, respectively. In some embodiments, for example, the image N₁ can be selected and/or displayed at target location A at an end 57 of path 51 because the end 57 of path 51 is not connected to another of the paths. In some embodiments, for example, the image N₂ can be selected and/or displayed at target location C because the path 53 is connected with two paths-path 51 and path 55.

In some embodiments, the communication device 550 can be configured to select one or more of the set of images 52 and/or display (e.g., display at a target location, display during a specified time period) the image(s) based on one or more portions (e.g., parameter values) of the directives 50. For example, the communication device 550 can be configured to trigger display of image N₂ at target location C on path 53 because the directive W2 includes one or more parameter values specifying that image N₂ should be displayed at target location C on path 53.

In some embodiments, the communication device 550 can be configured to select one or more of the set of images 52 and/or display (e.g., display at a target location, display during a specified time period) the image(s) based on one or more orientation indicators. The orientation indicators can be, for example, an indicator of an orientation of an object within an image from the set of images 52. In some embodiments, the orientation indicator associated with image N₁ can represent a first orientation of an object within image N₁ with respect to a second orientation (e.g., an origin position, a start position) of the object within image N₂. In some embodiments, for example, an image (e.g., image N₃) from the set of images 52 of an object can be selected and/or displayed at a particular target location associated with one or more of the paths 59 based on the image being associated with an orientation indicator representing a specified value.

In some embodiments, the communication device 550 can be configured to select one or more of the set of images 52 and/or display (e.g., display at a target location, display during a specified time period) the image(s) based on a map of neighbor relationships between images from the set of images 52. For example, image N₂ can be selected for display within the display 556 at target location B based on a relationship between image N₁ (which is selected for display at target location A) and image N₂.

In some embodiments, the communication device 550 can be configured to determine a timing for display of one or more of the set of images 52 based on a timing of processing one or more portions of the path(s) 59. For example, the image N₁ can be displayed at target location A as soon as the path 51 is determined at the communication device 550 based on directive W3. In some embodiments, the image N₁ can be displayed at target location A as soon as a location (within display 556) of a portion of the path 51 associated with target location A is determined at the communication device 550 based on directive W3.

In some embodiments, the communication device 550 can be configured to trigger display of one or more of the set of images 52 at one or more times (e.g., during a specified time period) based on one or more portions (e.g., parameter values) of the directives 50. For example, the communication device 550 can be configured to trigger display of image N₃ at target location B on path 51 at a specified time in response to an instruction from the directive W2 to display the image N₃ at target location B on path 51 at the specified time (e.g., within a specified time slot). In some embodiments, the communication device 550 can be configured to trigger display of image N₃ at target location B a specified time period after display of, for example, image N₁ at target location A based on one or more parameter values included in directive W2.

In some embodiments, images from the set of images 52 can be displayed along one or more portions of the paths 59 based on, for example, a velocity associated with the portion(s) of the path(s) 59. The velocity can be calculated based on a path time period (e.g., a time period during which a portion of the path is available) and a path length associated with a portion of a path 59. In other words, different velocities can be associated with different (e.g., overlapping, mutually exclusive) portions of a path 59.

For example, the path 51 can be associated with a direction D, a path length (not shown), and a time period. The direction D, the path length, and the time period can be specified within directive W3, which is used to define path 51. The time period and the path length can be used to determine, at the communication device 550, a velocity that can be associated with the entire path 51. Specifically, the velocity can be calculated based the time period divided by the path length. Accordingly, communication device 550 can be configured to trigger display of the image N₁ at target location A at a first time at the starting point of the path 51 (in accordance with direction D) as shown in FIG. 5. The image N₃ can be displayed at target location B at a second time after the first time. A duration between the first time and the second time can be calculated based on a product of the velocity and a distance (e.g., a length of a portion of the path length) between target location A and target location B.

In some embodiments, image N₃ can be moved along a portion of path 51 in accordance with direction E (as shown in FIG. 5) at a path velocity parameter value included the directive W3. The image N₃ can be moved along a portion of path 53 in accordance with direction E (as shown in FIG. 5) at a path velocity parameter value included the directive W2. If the path velocity parameter value associated with path 51 is different than the path velocity parameter value associated with path 53, a speed at which the image N₃ is moved along direction E by the communication device 550 can change at the transition between path 51 and path 53. In some embodiments, image N₃ can be moved along direction E (as shown in FIG. 5) at a velocity defined within a user preference (e.g., within a rule included in the user preference).

Although not shown, in some embodiments, additional images from the set of images 52 can be displayed between target location B and target location C so that, for example, rotational movement of an object and be represented. In such instances the images displayed between target location B and target location C can be serially displayed between target location B and target location C along mutually exclusive portions of the path 51 and path 53.

In some embodiments, the paths 59 and/or other processing related to the paths 59 (e.g., selection and/or display of images from the set of images 52) can be scaled up or down at the communication device 550. For example, the communication device 550 can be configured to determine whether or not one or more of the paths 59 would be, for example, too large to be included within an area of the display 556 if defined as described within one or more of the directives 50. Accordingly, the communication device 550 can be configured to scale the path(s) 59 so that the path(s) 59 can fit within the area of the display 556 in a desirable fashion. In some embodiments, for example, movement of an image from the set of images 52 at a specified velocity can be scaled up and/or down depending on, for example, the processing capability of the communication device 550.

Although not shown, in some embodiments, one or more glyphs can be displayed on (or near) one or more of the paths 59. In some embodiments, an application associated with (e.g., installed at, accessed from) the communication device 550 can be configured to include one or more glyphs along the path after the path is defined, or as the path is being defined within the display 556. For example, a line can be displayed along path 51 as path 51 is being defined within the display 556.

In some embodiments, the set of images 52 (or image resource) can be selected from library of sets of images (not shown). In some embodiments, the set of images 52 can be selected based on a user preference and/or a based on a specified canvas.

In some embodiments, the library of image resources can be, for example, downloaded and/or installed independent of an application (and/or other module) used to process images from the library of image resources and/or directives. In some embodiments, image resources can be added and/or removed from the library of image resources without modifying (or substantially without modifying) an application (and/or other module) configured to process the image resources and/or directives.

In some embodiments, the directives 50 can be stored at a host device (not shown). Each of the directives 50 can be retrieved from the host device in response to a request from the communication device 550. In some embodiments, the directives 50 can be streamed to the communication device 550 when the communication device 550 (and/or an application associated with the communication device 550) is available to receive the directives 50. In some embodiments, the directives 50 can be sent to the communication device 550 when the communication device 550 is available to receive the directives 50 and can be stored at the communication device 550. The directives 50 can be processed at the communication device 550 at a later time (e.g., at a later time in response to a request triggered by a user of the communication device 550). In some embodiments, one or more of the directives 50 can be sent in a group (e.g., within a data packet) to the communication device 550. In such instances, each of the directives 50 can be parsed from the group and processed at the communication device 550.

In some embodiments, each of the directives 50 can be sent (e.g., streamed), received, and/or processed in a particular order. In some embodiments, the directives 50 can be sent to the communication device 550 from, for example, a host in a particular order so that they can be processed at the communication device 550 in that order. Accordingly, the communication device 550 can be configured to process the directives 50 as they are received. In some embodiments, for example, each of the directives 50 can be processed at the communication device 550 in an order determined at the communication device 550 regardless of an order that the directives 50 are sent to (and/or received at) the communication device 550. The sequence for processing of the directives 50 can be specified within the directives 50 and/or within an instruction associated with the directives 50.

In some embodiments, the paths 59 and/or selected images from the set of images 52 can be displayed within a canvas at the display 556. Accordingly, at least a portion of a glyph associated with the paths 59 and/or at least a portion of an image from the set of images 52 can be displayed so that they are visible. In other words, at least a portion of a glyph associated with the paths 59 and/or at least a portion of an image from the set of images 52 can be displayed so that they appear as though they are on top of or within a canvas visible at display 556. In some embodiments, at least a portion of a glyph associated with the paths 59 and/or at least a portion of an image from the set of images 52 can be displayed behind at least a portion of canvas so that the portion of the glyph and/or the portion of the image from the set of images 52 are not visible to (e.g., hidden from view of) a user of the communication device 550. Additional details related to manipulating a display of a remote device and/or image resources are included in co-pending U.S. patent application bearing attorney docket no. SWAK-002/00US 311665-2001, filed on same date herewith, and entitled “METHODS AND APPARATUS FOR SELECTING AND/OR DISPLAYING IMAGES OF PERSPECTIVE VIEWS OF AN OBJECT AT A COMMUNICATION DEVICE,” and co-pending U.S. patent application bearing attorney docket no. SWAK-002/01US 311665-2004, filed on same date herewith, and entitled “METHODS AND APPARATUS FOR PROCESSING RELATED IMAGES OF AN OBJECT BASED ON DIRECTIVES;” each of which is incorporated herein by reference in its entirety.

As discussed above, directives can be defined based on user input at a communication device, and distributed to one or more other communication devices. In some embodiments, a display of a communication device can be partitioned such that a user of that communication device can send and receive directives (or view output based on received directives) at the partitioned portions of the display. For example, FIG. 6 shows a schematic illustration of display 610 of communication device 600 displaying symbols 640 that can be associated with a directive sent to and/or received from a remote communication device, according to another embodiment. Communication device 600 includes a processor (not shown) and a memory (not shown) and can be substantially similar to the communication devices described in FIG. 1. The display 610 of communication device 600 can be, for example, a touch-sensitive display.

The display 610 includes a first portion 620, a second portion 630 and a third portion 615. The first portion 620 of the display 610 is uniquely associated with a first remote communication device (not shown) such that when a user-selected indicator associated with the first portion 620 of the display 610 is received by the processor of communication device 600, a directive is sent to the first remote communication device via a communications session. For example, in the embodiment shown in FIG. 6, and as further described herein, a directive containing content representing one or more symbols 640 can be sent to the first remote communication device when the user of communication device 600 selects one or more of symbols 640 and traces a path to or in the direction of the first portion 620 of the display 610. In such embodiments, the directive sent to the first remote communication device can be stored in a memory of a host device (or at a communications session controller hosted at the host device) and can instruct a processor of the first remote communication device to display the one or more symbols on a display of the first remote communication device. Similarly, the second portion 630 of the display 610 is uniquely associated with a second remote communication device (not shown) such that when a user-selected indicator associated with the second portion 630 is received by the processor, a directive is sent to the second remote communication device.

In some embodiments, the first portion 620 of the display 610 and/or the second portion 630 of the display 610 can include a communication device identifier uniquely identifying the first portion 620 as being associated with the first remote communication device and/or the second portion 630 as being associated with the second remote communication device, respectively.

The third portion 615 of the display 610 is not associated with another communication device. Accordingly, the third portion 615 of the display 610 can be used to perform tasks local to communication device 600 and/or tasks not associated with the first remote communication device or the second remote communication device.

Multiple symbols 640 are displayed on the third portion 615 of the display 610. In some embodiments, for example, the symbols 640 are images representing playing cards. In other embodiments, the symbols can be glyphs, images, videos and/or the like representing anything displayed on the third portion of the display. A user of communication device 600 can send a directive associated with one or more of the symbols 640 to the first remote communication device or the second remote communication device by selecting one or more of the symbols 640 and tracing a path on the display 610 to or in the direction of the first portion 620 of the display 610 or the second portion 630 of the display, respectively, as further described herein.

In use, the first portion 620 of the display 610 and the second portion 630 of the display 610 are defined and associated with the first remote communication device and the second remote communication device by a user of communication device 600. As such, in one embodiment, a user defines the first portion 620 of the display 610 and/or the second portion 630 of the display 610. In other embodiments, a host device defines the first portion of the display and/or the second portion of the display.

In some embodiments, before the first portion 620 of the display 610 is associated with the first remote communication device, the first remote communication device receives an indication that communication device 600 is attempting to join a communications session which the first remote communication device has previously joined. Once a user of the first remote communication device authorizes or requests the initiation of the session, then the first portion 620 of the display screen 610 can be associated with the first remote communication device.

After the first portion 620 of the display 610 is associated with the first remote communication device via a communications session, communication device 600 can send directives to the first remote communication device. For example, as shown in FIG. 6, a user of communication device 600 can send a directive associated with a first symbol 642 (e.g., a playing card) to the first remote communication device. In some embodiments, the directive associated with the first symbol 642 can be sent to the first remote communication device when a portion of the first symbol 642 is within the first portion 620 of the display 610. In such embodiments, the user can move the first symbol 642 on the display to the first portion 620 of the display by selecting the first symbol 642 (e.g., touching the first symbol 642 with a finger) and then tracing a path A to the first portion 620 of the display 610. The processor of communication device 600 receives sensor data from the user touching the display indicating that the first symbol 642 was selected and that the user is tracing the path A. The processor causes the first symbol 642 to be displayed as moving on the display 610 along the path A. Once a portion of the first symbol 642 is displayed within the first portion 620 of the display 610, the processor sends a directive associated with the first symbol 642 to the first remote communication device, via a host device and/or a communications session controller hosted by the host device, as described above.

In other embodiments, a directive associated with the first symbol can be sent to the first remote communication device when the processor receives sensor data indicating a user-selected the first symbol and traced a path in a direction toward the first portion of the display. In such embodiments, the processor of the communication device recognizes the direction of the path toward the first portion of the display and the user need not trace the entire path to the first portion of the display. Thus, as the user begins to trace a path in the direction of the first portion of the screen, the processor can determine that the path extends to the first portion 620, and can send a directive associated with the first symbol to the first remote communication device.

In still other embodiments, a directive associated with the first symbol is sent to the first remote communication device when the processor receives sensor data indicating a user-selected the first symbol (e.g., touched the portion of the display displaying the first symbol) and then selected the first portion of the display (e.g., touched the first portion of the display). In such an embodiment, no path need be traced between the first symbol and the first portion of the display. In yet other embodiments, any other method of indicating that a directive associated with the first symbol is to be sent to the first remote communication device can be used.

The directive can be sent to an address of the first remote communication device and is received by the first remote communication device. The processor of the first remote communication device interprets the directive and causes the symbol to be displayed on the first remote communication device. In some embodiments, the symbol is also displayed within a portion of the first remote communication device associated with communication device 600. In some embodiments, the symbol can be displayed on a display of the first remote communication device differently than it is displayed on the display 610 of communication device 600. In such embodiments, for example, a playing card might appear to be face up on the first remote communication device, but face down on communication device 600. In some embodiments, if the first remote communication device is deactivated (e.g., powered off, without network connectivity), it receives the directive the next time it is activated (e.g., powered on, with network connectivity). In other embodiments, the host device can queue directives received from the communication device and wait for the first remote communication device to request the that the directives be sent to the first remote communication device.

Similar to the first symbol 642, a second symbol 644 can be sent to the second remote communication device. In some embodiments, the directive associated with the second symbol 644 can be sent to the second remote communication device when a portion of the second symbol 644 is within the second portion 630 of the display 610. In such embodiments, the user can move the second symbol 644 on the display to the second portion 630 of the display by selecting the second symbol 644 (e.g., touching the second symbol 644 with a finger) and then tracing a path B to the second portion 630 of the display 610. In other embodiments, a directive associated with the second symbol can be sent to the second remote communication device when the processor receives sensor data indicating a user-selected the second symbol and traced a path in a direction toward the second portion of the display. In still other embodiments, a directive associated with the second symbol is sent to the second remote communication device when the processor receives sensor data indicating a user-selected the second symbol and then selected the second portion of the display. In yet other embodiments, any other method of indicating that a directive associated with the second symbol is to be sent to the second remote communication device can be used.

After the processor of communication device 600 sends the directive to a host device, the host device receives and stores the directive in a memory of the host device. The directive is then sent to the second remote communication device. The processor of the second remote communication device interprets the directive and causes the symbol to be displayed on the second remote communication device.

Similar to sending a directive associated with a symbol to the first remote communication device or the second remote communication device, communication device 600 can receive one or more directives associated with symbols from the first remote communication device or the second remote communication device. In some embodiments, for example, a user of the first remote communication device can indicate that a directive associated with a symbol displayed on the display of the first remote communication device is to be sent to communication device 600. This can be done by any suitable method such as those described above. The directive associated with the symbol is then sent from the first remote communication device to communication device 600 via a host device and/or a communications session controller hosted by the host device. The processor of communication device 600 interprets the directive such that the symbol is displayed on the display 610 at or originating from first portion 620. Additional details related to defining and sending directives are included in co-pending U.S. patent application bearing attorney docket no. SWAK-003/00US 311665-2003, filed on same date herewith, and entitled “METHODS AND APPARATUS FOR REMOTE INTERACTION USING A PARTITIONED DISPLAY,” and co-pending U.S. patent application bearing attorney docket no. SWAK-003/01US 311665-2008, filed on same date herewith, and entitled “METHODS AND APPARATUS FOR REMOTE INTERACTION USING A PARTITIONED DISPLAY;” each of which is incorporated herein by reference in its entirety.

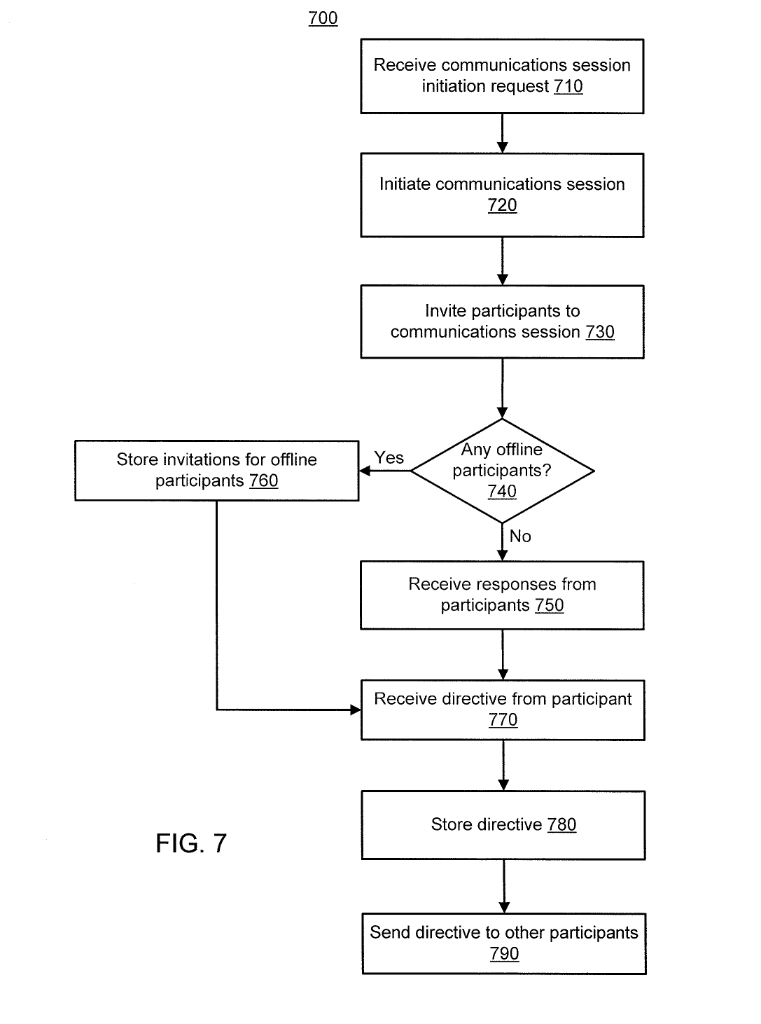

FIG. 7 is a flowchart that illustrates a method for initiating a communications session and distributing directives via the communications session, according to an embodiment. Method 700 can be implemented, for example, as a software module (e.g., source code, object code, one or more scripts, or instructions) stored at a memory and operable to be executed and/or interpreted or compiled at a processor operatively coupled to the memory at a server hosting a communications session controller. For example, processor-executable instructions stored at a memory of a server hosting a communications session controller can be executed at a processor at the server to cause the processor to execute the steps of method 700. In some embodiments, method 700 can be implemented as one or more hardware modules such as, for example, an application specific integrated circuit an ASIC, an FPGA, a processor, or other hardware module at a server hosting a communications session controller. In some embodiments, method 700 can be implemented as a combination of one or more hardware modules and software modules at a server hosting a communications session controller.

A communications session initiation request is received, at 710. The communications session initiation request can be received by, for example, a server configured to host one or more communications session controllers. In some embodiments the communications session initiation request can be received by a communications session controller. In other words, a communications session controller can be configured to organize or instantiate a communications session in addition to performing directive processing during the communications session. Said differently, a communications session controller can operate or function before and/or after a communications session is opened and/or closed. In some embodiments, the communications session initiation request can include a list or group of participant identifiers. Participant identifier can be, for example, unique identifiers associated with a communication device or a user of a communication device, and can be used by a communications session to identify, authentication, and/or authorize (e.g., to join or associate with the communications session) participants of the communications session (e.g., communication devices and/or users of communication devices the associated with the communications session). Additionally, participant identifiers can be used to distribute directives among the participants of the communications session.

In some embodiments, a communications session initiation request can include a unique identifier and/or a credential that can be used by a server (or host device) configured to host communications session to determine whether the communication device (or user of the communication device) is authorized or has permission to initiate a communications session. For example, a unique identifier can be associated with a user profile that has limited permissions (e.g., restrictions on which participants can be invited to a communications session, the types or classes of communications sessions that can be initiated, and/or the directive classes that can be allowed in a communications session) for initiating the communications session. Similarly, a user profile can include preferences or default values for communications session properties, characteristics, or parameters that can be accessed based on a unique identifier or credential provided at 710.

The communications session is initiated, at 720. Initiation of the communications session can include, for example, instantiating one or more software modules or applications (e.g., a communications session controller associated with the communications session), provisioning of memory for the communications session, provisioning of hardware modules (e.g., communications session modules), defining parameters of the communications session, and/or other initialization or setup procedures or routines. Initiation of a communications session can also be referred to as opening a communications session. In some embodiments, a local memory such as a RAM and/or virtual memory space is provisioned or allocated and a remote memory such as a relational or object-based database is provisioned or allocated during initiation of a communications session.

In some embodiments, the memory (or memories) can be associated with the communications session, for example, based on an identifier of the communications session. In some embodiments, the memory (or memories) can be associated with the communications device from which the communications session initiation request was received. For example, the memory (or memories) can be associated with a user or account profile related to a unique identifier related to that communications device (or a user thereof). In some embodiments, the memory (or memories) can similarly be associated with one or more communications device that are invited to the communications session.

In some embodiments, initiation of the communications session includes determining whether the communication device or the user of the communication device has sufficient permissions or access rights to initiate the communications session. If the communication device or the user of the communication device does not have sufficient permissions or access rights to initiate the communications session, the communications session can not be opened. In some embodiments, initiation of a communications session includes requesting permission from a moderator (e.g., a moderator device) to initiate the communications session. For example, a parent can configure the user profile of a child such that the parent can approve or authorize (e.g., via that parent's communication device acting as a moderator device) initiation of a communications session before the child can initiate the communications session. In some embodiments, the server can send a directive to notify the communication device (or the user thereof) that the communications session was not initiated.

After the communications session is initiated, participants are invited to the communications session, at 730. For example, directives including a communications session invitation can be sent to participants identified in the communications session initiation request. At 740, the communications session controller (or server hosting the communications session controller) can determine whether any of the participants are offline or disconnected from the network or server. In other words, the server or communications session controller can detect presence information about communication devices related to unique identifiers associated with the participants. If any participants are offline, the communications session controller can store communications session invitations for the offline participants, at 760.

For example, the communications session controller can store the communications session identifier in a memory storing the user profile of an offline participant such that the communications session invitation is sent to the participant (e.g., a communication device associated with the participant) when that participant logs onto or connects to the server. If all the participants are online (e.g., connected to the network or server), the communications session controller receives responses from the online participants, at 750. The responses can include indications of an intention to join the communications session, indications of an intention not to join a communications session, and/or comments related to the communications session. In other words, an invited participant can be online, but not joining the communications session. In some embodiments, the participant initiating the communications session can receive a notification (e.g., a directive containing a notification) that one or more participants are offline and/or will not be associated with the communications session.

Online participants can send a communications session access request to the communications session controller (e.g., via one or more communications session links) to join the communications session. The communications session access request can include, for example, a unique identifier, a credential, and/or other information. In some embodiments, a communications session controller can associate each online participant that sends a communications session access request with the communications session. In other words, the communications session controller can associate participants with the communications session without authenticating or verifying permission of participants. In some embodiments, a communications session controller can authenticate participants with the communications session (e.g., based on information such as a unique identifier or a credential included in the communications session access request) before associating the participants with the communications session.

Similar to step 720 related to initiating a communications session, the communications session controller can access user or account profiles of the participants (e.g., based on a unique identifier or credential included in the communications session access request) to determine whether each participant is allowed to join the communications session. In some embodiments, associating a participant with a communications session includes requesting permission from a moderator (e.g., a moderator device) to associate the participant with the communications session.

After participants have been associated with the communications session, directives can be distributed among that participants of the communications session. A directive can be received from a participant, at 770; that directive can be stored, at 780; and that directive can be sent to other participants, at 790. These steps can be repeated for each directive that is distributed via the communications session. After the participants are finished sending and/or receiving directive, the communications session can be closed. In some embodiments, a participant such as the participant that initiated the communications session can unilaterally close the communications session by sending a communications session close signal to the communications session controller. In some embodiments, the communications session can close after a period of inactivity (e.g., a parameter of the communications session can define a time period after which the communications session will close if no directive have been sent during the time period), or after each of the participants has disassociated with the communications session. In some embodiments, a moderator can send a communications session close signal to the communications session controller, and the communication session controller will close the communications session in response to the communications session close signal.

In some embodiments, method 700 can include more or fewer steps than illustrated in FIG. 7. For example, method 700 can include disassociating a participant from the communications session in response to a disassociation signal such as a disassociation signal sent by a moderator device of the communications session controller or that participant. Additionally, in some embodiments, steps of method 700 can be rearranged. As illustrated in FIG. 7, communications session invitations are sent to participants before determining whether any of the invited participants are offline. In some embodiments, steps 730 and 740 can be reversed such that the communications session controller first determines whether any participants are offline before sending the communications session invitations.

In some embodiments, directives can be stored within a memory associated with a communications session or a participant (e.g., memory of a user or account profile) such that directives, rather than or in addition to a communications session invitation, are sent to a participant or communication device when that communication device connect to the network or the server. In other words, directives from a communications session can be sent to a participant when that participant come online (e.g., when the server receives network connectivity or presence information related to that participant). In some embodiments, a participant that sends a directive to an offline participant (e.g., a participant that joined the communications session and later was disconnected from the network or disassociated from the communications session) via a communications session can receive a notification that the directive was stored or queued for later delivery to the offline participant.

In some embodiments, communications session invitations can be sent to communication devices at any time while a communications session is active. For example, a communication device can receive an indication that another communication device is accessible via a network, and that communication device can request that a communications session invitation be sent to the other communication device. In some embodiments, the communication device can send the communications session invitation directly to the other communication device. In some embodiments, communication device can be removed from a communications session. For example, a communication device participating in a communications session such as the communication device that requested initiation of the communications session can request (e.g., from a communications session controller) that a communication device participating in the communications session be removed to disassociated from the communications session. In some embodiments, a moderator device associated with the communications session can request that communication device be removed from the communications session. In some embodiments, communication devices having a remove permission relative to a communications session can request that a communication device be removed from that communications session.

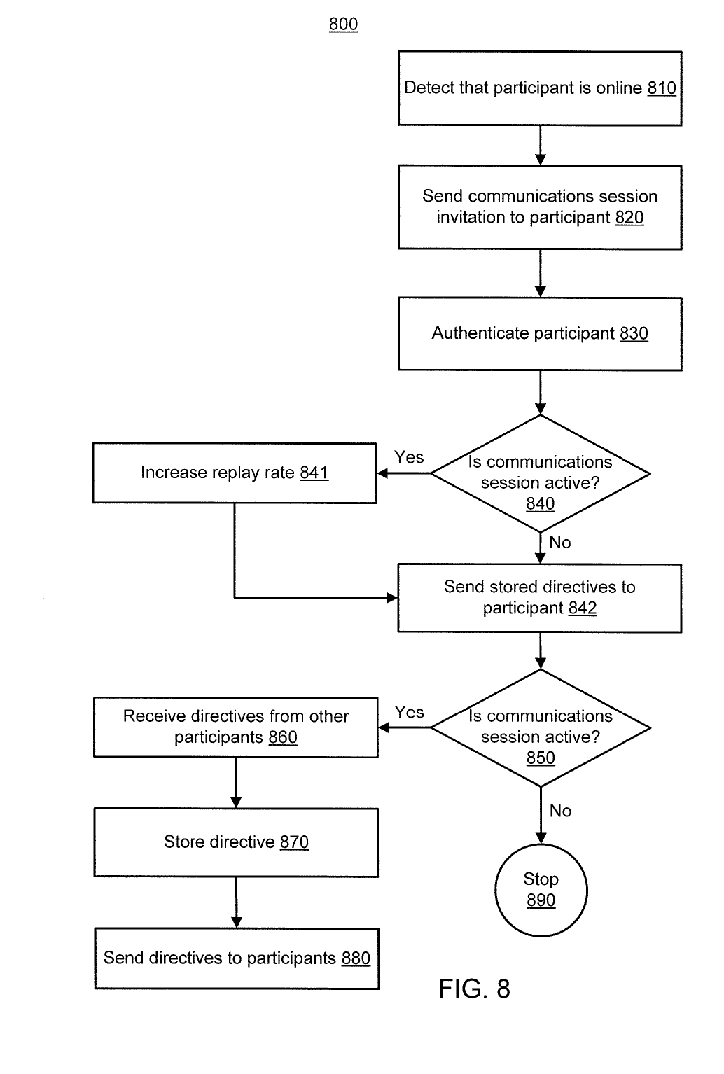

FIG. 8 is a flowchart that illustrates a method for providing directives to a communication device via a communications session, according to an embodiment. Method 800 can be implemented, for example, as a software module (e.g., source code, object code, one or more scripts, or instructions) stored at a memory and operable to be executed and/or interpreted or compiled at a processor operatively coupled to the memory at a server hosting a communications session controller. For example, processor-executable instructions stored at a memory of a server hosting a communications session controller can be executed at a processor at the server to cause the processor to execute the steps of method 800. In some embodiments, method 800 can be implemented as one or more hardware modules such as, for example, an application specific integrated circuit an ASIC, an FPGA, a processor, or other hardware module at server hosting a communications session controller. In some embodiments, method 800 can be implemented as a combination of one or more hardware modules and software modules at a server hosting a communications session controller.

A server or application executing at the server detects that an invited participant to a communications session (e.g., a communication device or a user of a communication device) is online, at 810. In other words, the server can be configured to detect that a communication device has connected to a network to which the server is also connected, or that the communication device has connected to the server. For example, the server can host one or more software modules configured to receive logon requests from communication devices. In some embodiments, a communications session controller can be configured to receive logon requests from communication devices. The server can receive a logon request and update a status of a unique identifier or an account or user profile to online. In some embodiments, the account profile can include unique identifiers associated with other communication devices (e.g., individuals and/or users of communication devices), and the server can provide a response to the logon request including status information about the other communication devices such as, for example, the current availability status or presence information (e.g., connectivity to the network and/or to the server) of each communication device.

In some embodiments, the server can update the presence information as communication devices log onto the server, log off from the server, and/or are disconnected from the server (e.g., due to a network connection failure). For example, a communication device can logon to a server and receive an indication that five other communication devices are online and that three other communication devices are offline. That communication device can receive a notification when the status of one of the offline communication devices changes to online (e.g., when one of the offline communication devices connects to the server), and can receive another notification when the status of one of the online communication devices changes to offline (e.g., when one of the online communication devices disconnects from the server). In other words, the server can maintain presence information about the communication devices, and can provide updates to other communication devices when the status of another communication devices changes.

As discussed above, a communications session invitation can be stored for a participant of a communications session (e.g., a communication device invited to a communications session) if that participant is offline when the communications session is initiated or opened. After the server detects that a participant is online, the server can determine whether any communications session invitations are stored for that participant. For example, communications session invitations for a participant can be stored within a user or account profile associated with that participant. Alternatively, communications session invitations can be stored at another memory such as, for example, a hash table indexed by a hash of a unique identifier associated with a participant. The server can perform a hash on the unique identifier to access any stored communications session identifier associated with the participant with which the unique identifier is associated. The server can then send the communications session invitation to the participant, at 820.

The participant can receive the communications session invitation or invitations and send a communications session access request to the server to access the directives distributed via a communications session associated with a communications session invitation. For example, a communication device can receive multiple communications session invitations from the server after logging onto the server. The communication device can notify a user of the communication device (e.g., via icons, messages, windows, and/or other notifications) that communications session invitations have been received. The user of the communication device can then select from the communication session invitations which communication session to join, and the communication device can send a communications session access request to the server in response to the selection of the user. In some embodiments, a communication device (or client a module such as a software module) can include default selection criteria and select a communications session to join (or access) without intervention of selection from a user. For example, a participant can receive two communications session invitations. A first communications session can be inactive or closed when a participant received (or viewed) the communications session invitation to the first communications session, and the second communications session can be active or open when the participant received (or viewed) the communications session invitation to the second communications session. The communication device can be configured to join the currently open communications session without selection of a communications session by a the participant.

After the participant has sent a communications session access request in response to the communications session invitation (and that communications session access request has been received by the server), the participant can be authenticated by the server for the communications session, at 830. As discussed with respect to method 700 illustrated in FIG. 7, the communications session access request can include a credential, a unique identifier, and/or some other value that the server and/or communications module can use to authenticate the participant. If the communications session is active, the server can authenticate the participant with the communications session directly (e.g., with a communications session controller associated with the communications session). If the communications session is inactive, the server can open the communications session based on parameters of the communications session stored at a memory at which the directives of that communications session are stored or archived, and then authenticate the participant based on parameters of the communications session and/or parameters associated with the participant that are stored, for example, in a user profile of the participant. For example, the server can instantiate a communications session controller based on the stored parameters.

In some embodiments, the server (or the communications session controller hosted at the server) can determine whether the communication session is active (i.e., currently open) or inactive (i.e., currently or previously closed), at 840. If the communications session is active, a directive replay rate can be increased, at 841. After the participant is authenticated at the communications session, the communications session controller can send stored directives to the participant, at 842. In other words, the directives that have been stored at a memory related to the communications session are sent to the participant such that the participant receives the directives as though the participant had participated in the communications session from the beginning of the communications session. Because the directives are sent one at a time, the participant views the progression of the communications session, rather than the final or current state of the communications session or conversation. In other words, directives are not aggregated into a single composite stream including multiple classes or directives such as a video of the effects or results of the directives at a communication device (e.g., a video of screenshots), but are sent to and processed separately by the communication device. This can allow the participant to, for example, experience the pace and development of the communications session.

In some embodiments, the directives can be replayed in real-time (e.g., directives are sent at the same rate they were received by the communications system). In other words, the directive replay rate can have a ratio of 1:1 with the rate at which the directives were received. In some embodiments, as such as that illustrated in FIG. 8, the directive replay can be increased, for example, if the communications session is active when the participant authenticated with the communications module. If the directive replay rate is increased, directives can be sent to the participant from the communications session controller at a rate higher than they were received. This can produce a fast-forward effect, allowing the participant to receive each directive as it was received at the communications session controller, but in a shorter amount of time. In some embodiments, these directives can be referred to as a stream of directives or a directive stream. Additionally, if the communications session is active, this can allow the participant to catch up or become current in a communications session, and then begin to receive directives in real-time after receiving each stored directive.

In some embodiments, a participant can increase or decrease a directive replay rate dynamically as the participant receives directives. For example, a user interface at the communication device can allow a user of the communication device to indicate that the directive replay rate should be increased or decreased. The communication device can send a signal related to an increased or decreased directive replay rate to the communications session controller, and the communications session controller can increase or decrease the directive replay rate accordingly.

After the stored directives have been sent to the participant, the communications session controller can determine whether the communications session is active, at 850. In other words, the communications session controller can determine whether the communications session has been previously closed. If the communications session is inactive, the communications session controller can disassociate the participant from the communications session and/or provide a notification to the participant that the communications session is closed, at 890.

If the communications session is active, the communications session controller can begin to send directives to the participant in real-time (e.g., directives are sent as they are received). As illustrated in steps 860, 870 and 880, the communications session controller can continue to receive directives, store directives, and send directives to the participants of the communications session. In other words, a participant that joins the communications session late (e.g., because that participant was offline when the communications session was opened) can become current in the communications session and then receive real-time directives via an active communications session.

In some embodiments, method 800 can include more or fewer steps than illustrated in FIG. 8. For example, method 800 can skip or not include step 842 if a communications session is active. Alternatively, only some of the stored directives (e.g., the most recent stored directives) are sent to the participant, at 842. Thus, the participant can begin to receive real-time directives without receiving stored directives. In some embodiments, the communications session controller can flood the participant with the stored directives (e.g., send the stored directives to the participant as quickly as possible after the participant is authenticated with the communications session). In some embodiments, a client software module or other module configured to receive and process directives can vary a rate at which directives are processed to simulate altering a directive replay rate at the communications session controller. Furthermore, in some embodiments, the participant is not authenticated with the communications session, but is associated with the communications session without authentication.

Additionally, in some embodiments, steps of method 800 can be rearranged. For example, the communications session controller (or the server hosting the communications session controller) can determine whether the communications system is active before authenticating the participant or before sending the communications session invitations.

In some embodiments, a communications session controller can concurrently process real-time directive (e.g., receive real-time directives, store real-time directives, and distribute real-time directives to some participants) and send stored directives to other participants. Additionally, in some embodiments, a participant can restart a communications session if the communications session is inactive after the participant receives the stored directives. For example, unique identifiers of the participants of the communications session can be stored at a memory associated with the communications system, and the participant can provide a communication session restart request to the communications session controller after step 850. The communications session controller can then restart the communications session using a process similar to that discussed in relation to initiating a communications session with respect to FIG. 7. In some embodiments, attributes, characteristics, and/or parameters of the closed or inactive communications session can be used to restart the communications session. For example, a participant list stored at a memory associated with the communications session can be used to invite participants to the communications session.

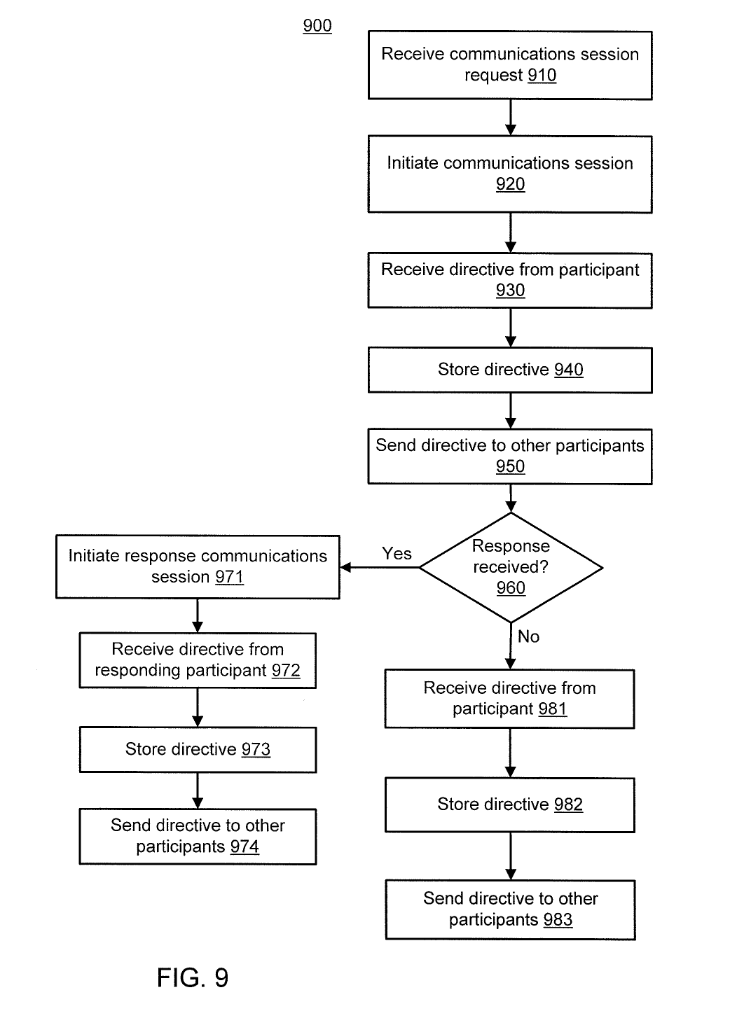

FIG. 9 is a flowchart that illustrates method for initiating a unilateral communications session and distributing directives via the communications session, according to an embodiment. Method 900 can be implemented, for example, as a software module (e.g., source code, object code, one or more scripts, or instructions) stored at a memory and operable to be executed and/or interpreted or compiled at a processor operatively coupled to the memory at a server hosting a communications session controller. For example, processor-executable instructions stored at a memory of a server hosting a communications session controller can be executed at a processor at the server to cause the processor to execute the steps of method 900. In some embodiments, method 900 can be implemented as one or more hardware modules such as, for example, an application specific integrated circuit an ASIC, an FPGA, a processor, or other hardware module at server hosting a communications session controller. In some embodiments, method 900 can be implemented as a combination of one or more hardware modules and software modules at a server hosting a communications session controller.

A communications session initiation request is received, at 910. In some embodiments, the communications session initiation request can include a list or group of participant identifiers. Participant identifiers can be, for example, unique identifiers associated with a communication device or a user of a communication device, and can be used by a communications session controller to identify, authentication, and/or authorize (e.g., to join or associate with the communications session) participants of the communications session (e.g., communication devices and/or users of communication devices the associated with the communications session). Additionally, participant identifier can be used to distribute directives among the participants of the communications session.

In some embodiments, a communications session initiation request can include a unique identifier and/or a credential that can be used by a server configured to host a communications session controller to determine whether the communication device (or user of the communication device) is authorized or has permission to initiate a communications session. For example, a unique identifier can be associated with a user profile that has limited permissions (e.g., restrictions on which participants can be invited to a communications session, the types or classes of communications sessions that can be initiated, and/or the directive classes that can be allowed in a communications session) for initiating the communications session. Similarly, a user profile can include preferences or default values for communications session properties, characteristics, or parameters that can be accessed based on a unique identifier or credential provided at 910.

The communications session is initiated, at 920. Initiation of the communications session can include, for example, instantiating one or more software modules or applications (e.g., instantiating a communications session controller associated with the communications session), provisioning of memory for the communications session, provisioning of hardware modules (e.g., communications modules), defining parameters of the communications session, and/or other initialization or setup procedures or routines. Initiation of a communications session can also be referred to as opening a communications session. In some embodiments, a local memory for a communications session controller such as a RAM and/or virtual memory space is provisioned or allocated and a remote memory such as a relational or object-based database is provisioned or allocated during initiation of a communications session. In some embodiments, initiation of the communications session includes determining whether the communication device or the user of the communication device has sufficient permissions or access rights to initiate the communications session. If the communication device or the user of the communication device does not have sufficient permissions or access rights to initiate the communications session, the communications session can not be opened. In some embodiments, initiation of a communications session includes requesting permission from a moderator (e.g., a moderator device) to initiate the communications session. For example, a parent can configure the user profile of a child such that the parent can approve (e.g., via that parent's communication device) initiation of a communications session before the child can initiate the communications session. In some embodiments, the server can send a directive to notify the communication device (or the user thereof) that the communications session was not initiated.

After the communications session is initiated, the participant can send directives to other participants via the communications session. As illustrated in FIG. 9, a directive can be received from the participant, at 930; that directive can be stored, at 940; and that directive can be sent to other participants, at 950. If no response is received, at 960, the participant can continue to send directives. For example, as illustrated in FIG. 9, a directive can be received from the participant, at 981; that directive can be stored, at 982; and that directive can be sent to other participants, at 983.

In some embodiments, another participant (“the second participant”) associated with the communications session can respond to a directive from the participant that sent that directive (“the first participant”) in a response communications session. In other words, in some embodiments, communications sessions can be unilateral or one-way communications sessions. If a response is received, at 960, a response communications session is initiated, at 971. The response communications session can be initiated as discussed above with respect to communications sessions generically. Additionally, the response communications session can inherit or import properties, parameters, and a list of invited participants. In some embodiments, the participants that were invited to the initial communications session, are also invited to the response communications session. In some embodiments, only the first participant and the second participant are invited to the response communications session.

In some embodiments, the response communications session can be related to or associated with the initial communications session. For example, both communications sessions can be stored within (or share) a portion of a memory such that both sessions can be accessed after one or both sessions are closed. In other words, directives from both communications sessions can be requested and received at a later time by an participant invited to either or both communications sessions (i.e., the initial communications session and the response communications session). In some embodiments, participants can receive only the directives stored at a memory associated with the communications session (e.g., the initial communications session or the response communications session) to which they were invited.

The second participant, can send directives via the response communications session as illustrated in steps 972, 973 and 974. As illustrated in FIG. 9, these directives can be stored at the response communications session and distributed to other participants of the response communications session. Similarly, the first participant can continue to send directives via the initial communications session as illustrated in steps 981, 982 and 983. Additional response communications session can be initiated if other participants send directives in response to a directive sent by the first participant or the second participant, and the additional response communications sessions can be associated with the initial communications session and/or the response communications session. After the participants are finished sending and/or receiving directive, the communications sessions can be closed.

In some embodiments, method 900 can include more or fewer steps than illustrated in FIG. 9. For example, in some embodiments, the participants are authenticated with the communications session (e.g., initial and/or response) before being associated with that communications session. Furthermore, in some embodiments, directives sent in response to a directive can be sent within or to a single communications session. In other words, in some embodiments the communications session can be bi- or multi-directional. Said differently, directives can be broadcast to and from all participants of the communications session by a communications session controller of the communications session. Alternatively, directives can be sent to single participants or groups of participants based on, for example, hardware and/or network identifiers such as network address of (or associated with) those participants. Such directionality properties of communications session can be controlled by parameters of the communications session that be can set or changed, for example, when the communications session is initiated, dynamically during operation of the communications session, and/or by a moderator associated with the communications session (e.g., the moderator can send control signal to the communications session controller to change properties of the communications session). Additionally, in some embodiments, steps of method 900 can be rearranged. For example, a response can be received from the second participant before the first participant sends any directives.

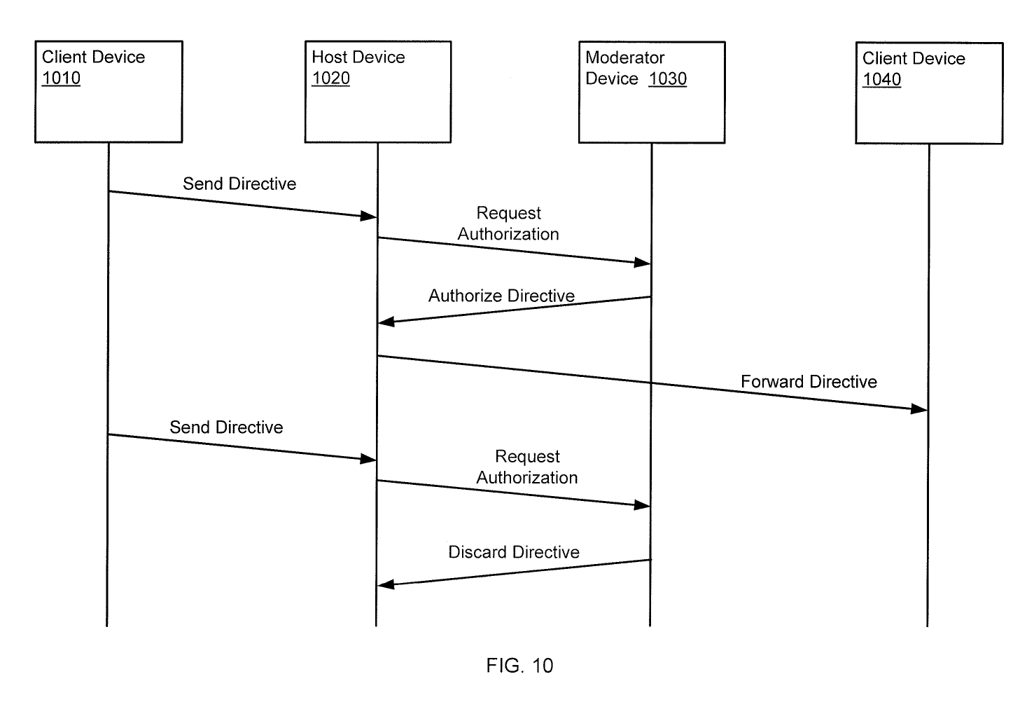

FIG. 10 is a sequence diagram that illustrates a method for distributing a directive, according to an embodiment. Method 1000 can be implemented, for example, as a software module (e.g., source code, object code, one or more scripts, or instructions) stored at a memory and operable to be executed and/or interpreted or compiled at a processor operatively coupled to the memory at a server hosting a communications session controller. For example, processor-executable instructions stored at a memory of a server hosting a communications session controller can be executed at a processor at the server to cause the processor to execute the steps of method 1000. In some embodiments, method 1000 can be implemented as one or more hardware modules such as, for example, an application specific integrated circuit an ASIC, an FPGA, a processor, or other hardware module at server hosting a communications session controller. In some embodiments, method 1000 can be implemented as a combination of one or more hardware modules and software modules at a server hosting a communications session controller.

A communications session controller is hosted at host device 1020, and client device 1010 and client device 1040 are associated with a communications session including the communications session controller and communications session links between the communications session controller at host device 1020 and client devices 1010 and 1040. Additionally, the communications session can include a communications session link between the communications session controller at host device 1020 and moderator device 1030. The communications session controller is configured to request authorization to forward directives from moderator device 1030. As illustrated in FIG. 10, client device 1010 sends a directive to the communications session controller that is hosted at host device 1020, and the communications session controller requests authorization to forward that directive from moderator device 1030. Moderator device 1030 authorizes the directive, and the communications session controller forwards the directive to client device 1040.

In some embodiments, if moderator device 1030 does not authorize a directive, that directive can be discarded and not forwarded. For example, as illustrated in FIG. 10, client device 1010 sends another directive to the communications session controller after the earlier sent directive is forwarded to client device 1040. The communications session controller requests authorization from moderator device 1030 to forward the directive to client device 1040. Moderator device responds to the request for authorization with a discard directive signal, and the communications session controller discards (e.g., does not forward) the directive in response to the discard directive signal. In some embodiments, authorization to forward a directive and/or discard directive signals are directives and are stored at a memory of the communications session with other directives. In some embodiments, a directive is removed from a memory of the communications session if a discard directive signal related to that directive is received by the communications session controller.

In some embodiments, a communications session controller can request authorization for each directive it receives before forwarding that directive. In some embodiments, a communications session controller can determine whether a directive is a monitored directive, and request authorization only for monitored directives. In other words, a communications session controller can determine whether a directive is a monitored directive before forwarding that directive. Monitored directives can be defined based on various parameters of a communications session and/or parameters of user or account profiles associated with participants of a communications session. For example, a communications session can include parameters specifying that directives broadcast to all participants, directives sent during a particular time period, and/or directives of particular directive classes (e.g., a monitored directive class) should be authorized by the moderator device before these directives are forwarded. Additionally, parameters of an account profile associated with a participant of a communications session can specify that directives sent to or from a particular participant or of particular directive classes should be authorized before these directives are forwarded. Furthermore, the definitions of monitored directives can be changed dynamically while a communications session is active. For example, a moderator can request that all directives to a particular participant be forwarded to the moderator device for preview and authorization at one time, and then request at a later time that only directives of a particular directive class that are sent to that participant be forwarded to the moderator device for preview and authorization.

In some embodiments, a communications session controller can send a communications session invitation to a moderator device when the communications session controller receives a directive of a monitored directive class it the moderator device is not already associated with the communications session. In other words, a moderator device can associate with a communications session (e.g., in response to a communications session invitation triggered by a directive of a monitored directive class) before receiving a directive.

Similarly, in some embodiments, a participant of a communications session can send a discard directive signal or request to the communications session controller of that communications session. For example, a participant can send a directive to the communications session controller and later, generally shortly thereafter, determine that that directive should not be sent to other participants. This can allow a participant to pull back or rescind a directive before it is delivered. For example, a participant might want to pull back a misspelled word or a malformed glyph before the directives describing these errors are sent via the communications session. The participant can send a discard directive request to the communications session controller, and the communications session controller can discard the directive if that directive has not already been forwarded or sent to other participants. In some embodiments, the directive can be stored at the communication session before the discard directive request is received at the communications session controller, and the directive can be removed or erased from a memory of the communications session after the discard directive request is received at the communications session controller. In some embodiments, the directive can be stored by the communications session controller in an archive memory such as a database, and at a RAM such as a transmission buffer from which the directive can be sent via a communications module operatively coupled to the communications session controller. After the discard directive request is received, the directive can be removed from the transmission buffer, but not from the database. In some embodiments, the discard directive request can be directive and is also stored at the database. In some embodiments, the directive can be removed from both the transmission buffer and the database (or other archive storage) in response to the discard directive request.

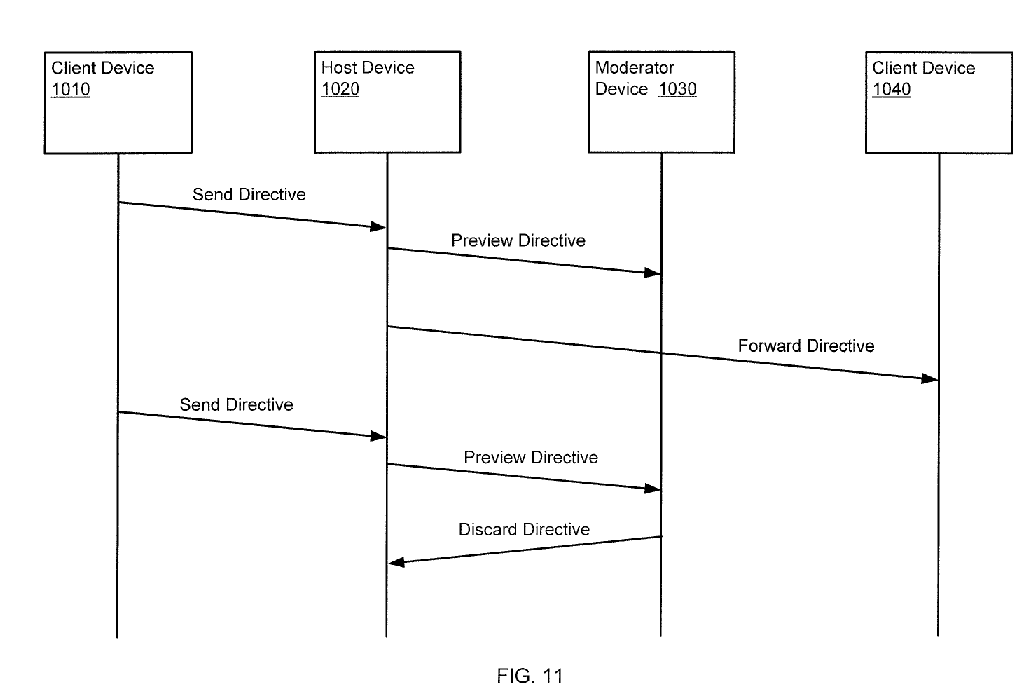

FIG. 11 is a sequence diagram that illustrates another method for distributing a directive, according to an embodiment. Method 1100 can be implemented, for example, as a software module (e.g., source code, object code, one or more scripts, or instructions) stored at a memory and operable to be executed and/or interpreted or compiled at a processor operatively coupled to the memory at a server hosting a communications session controller. For example, processor-executable instructions stored at a memory of a server hosting a communications session controller can be executed at a processor at the server to cause the processor to execute the steps of method 1100. In some embodiments, method 1100 can be implemented as one or more hardware modules such as, for example, an application specific integrated circuit an ASIC, an FPGA, a processor, or other hardware module at server hosting a communications session controller. In some embodiments, method 1100 can be implemented as a combination of one or more hardware modules and software modules at a server hosting a communications session controller.

A communications session controller is hosted at host device 1020, and client device 1010 and client device 1040 are associated with a communications session including the communications session controller and communications session links between the communications session controller at host device 1020 and client devices 1010 and 1040. Additionally, the communications session can include a communications session link between the communications session controller at host device 1020 and moderator device 1030. The communications session controller is configured to send directives to moderator device 1030 for preview before forwarding the directives to client device 1040. As illustrated in FIG. 11, client device 1010 sends a directive to the communications session controller that is hosted at host device 1020, and the communications session controller sends that directive to moderator device 1030 for preview before forwarding that directive to client device 1040. The directive is then forwarded to client device 1040.

In some embodiments, the communications session controller can delay forwarding directives such that moderator device 1030 has an opportunity to send a discard directive signal to the communications session controller such that that directive can be discarded and not forwarded. For example, as illustrated in FIG. 11, client device 1010 sends another directive to the communications session controller after the earlier sent directive is forwarded to client device 1040. The communications session controller sends that directive to moderator device 1030 for preview before forwarding that directive to client device 1040. Moderator device responds with a discard directive signal, and the communications session controller discards (e.g., does not forward) the directive in response to the discard directive signal. In some embodiments, a directive can be forwarded to a client device after a time period associated with the preview at the moderator (e.g., a preview time period) expires. Thus, in some embodiments, moderator device 1030 can respond before a deadline (e.g., before the expiration of a preview time period) to prevent a directive from being forwarded by the communications session controller hosted at host device 1020.

In some embodiments, a communications session controller can send each directive it receives to a moderator for preview before forwarding that directive. In some embodiments, a communications session controller can determine whether a directive is a monitored directive, and send only monitored directive to a moderator for preview before forwarding that directive. In other words, a communications session controller can determine whether a directive is a monitored directive before sending that directive for preview at a moderator device.

Some embodiments described herein relate to a computer storage product with a computer- or processor-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (“ASICs”), Programmable Logic Devices (“PLDs”), and Read-Only Memory (“ROM”) and Random-Access Memory (“RAM”) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java™, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. For example, although certain methods of authentication are discussed, other authentication methods can be used. Any portion of the apparatus and/or methods described herein may be combined in any combination, except mutually exclusive combinations. The embodiments described herein can include various combinations and/or sub-combinations of the functions, components and/or features of the different embodiments described. For example, in some embodiments, features of one module described herein can be included in another module to reduce the number of discrete components of an apparatus. Additionally, in some embodiments, for example, some modules described herein can be implemented in software or code executing on a processor and other modules can be implemented in hardware such as application-specific integrated circuits or semiconductor chips.

What is claimed is:

1. A processor-readable medium storing code representing instructions that when executed by a processor cause the processor to:
detect at a first time an availability, within a network, of a communications device based on a unique identifier;
access, at a second time after the first time, a communications session invitation associated with the unique identifier, the communications session invitation associated with a communications session, the communications session being initiated before the first time;
send, after the second time, a first directive of the communications session to the communications device; and
send, after the second time, a second directive of the communications session to the communications device.

2. The processor-readable medium of claim 1, the processor-readable medium further storing code representing instruction that when executed by the processor cause the processor to:
receive an association request from the communications device before the first directive is sent and before the second directive is sent, the association request including a credential; and
authenticate the communications device based on the credential.

3. The processor-readable medium of claim 1, wherein:
the communications session is an inactive communications session.

4. The processor-readable medium of claim 1, wherein:
the communications session is an active communications session.

5. The processor-readable medium of claim 1, wherein:
the first directive is an archived directive; and
the second directive is a real-time directive.

6. The processor-readable medium of claim 1, wherein:
the communications device is a first communications device;
the first directive includes a directive description portion and a directive content portion, the directive description portion of the first directive including an identifier of a first directive class, the directive content portion of the first directive including a data set defined at a second communications device; and
the second directive includes a directive description portion and a directive content portion, the directive description portion of the second directive including an identifier of a second directive class, the directive content portion of the second directive including a data set defined at the second communications device.

7. The processor-readable medium of claim 1, wherein the communications device is a first communications device, the processor-readable medium further storing code representing instruction that when executed by the processor cause the processor to:
send an indication of the availability of the first communications device to a second communications device associated with the communications session.

8. A method, comprising:
receiving, at a first time, from a client device network connectivity information associated with the client device, the network connectivity information including a unique identifier associated with the client device;
accessing, at a second time after the first time, a communications session invitation list associated with the unique identifier, the communications session invitation list including a first communications session invitation and a second communications session invitation, the first communications session invitation associated with a first communications session initiated before the first time, the second communications session invitation associated with a second communications session initiated before the first time;
sending the first communications session invitation and the second communications session invitation to the client device;
receiving a communications session access request associated with the first communications session; and
associating the client device with the first communications session.

9. The method of claim 8, wherein:
the communications session access request includes a credential associated with the unique identifier.

10. The method of claim 8, wherein:
the first communications session is an active communications session; and
the second communications session is an inactive communication session.

11. The method of claim 8, wherein the first communications session is an inactive communications session including a plurality of directives, the method further comprising:
sending the plurality of directives to the client device substantially at a single time.

12. The method of claim 8, further comprising:
receiving a communications session access request associated with the second communications session; and
sending a plurality of directives of the second communications session to the client device.

13. The method of claim 8, wherein the first communications session is an active communications system having a plurality of archived directives, the method further comprising:
sending the plurality of archived directives to the client device substantially at a single time; and
sending a plurality of real-time directives to the client device after the sending the plurality of archived directives.

14. The method of claim 8, further comprising:
authenticating the client device after the receiving a communications session access request and before the associating the client device with the first communications session.

15. A method, comprising:
detecting user input at a communications device, the communications device associated with a communications session that is configured to store a plurality of directives;
defining a first data set based and a second data set based on a parameter of the communications system, the first data set derived from a first portion of the user input, the second data set derived from a second portion of the user input;
associating a first description of the first data set with the first data set and associating a second description of the second data set with the second data set, the second description being different from the first description;
defining a first directive and a second directive, the first directive having an identifier associated with the first description within a directive description portion of the first directive, the first directive having the first data set within a directive content portion of the first directive, the second directive having an identifier associated with the second description within a directive description portion of the second directive, the second directive having the second data set within a directive content portion of the second directive; and
sending, via the communications session, the first directive and the second directive to a plurality of communications devices associated with the communications session.

16. The method of claim 15, further comprising:
receiving a communications session invitation associated with the communications session before the detecting; and
sending a communications session association request to the communications session before the detecting in response to the communications session invitation.

17. The method of claim 15, wherein:
the first directive and the second directive are stored at a memory associated with the communications session such that the first directive and the second directive are accessible after the communications session is closed.

18. The method of claim 15, further comprising:
receiving a third directive at the communications device, the third directive including a directive description portion and a directive content portion;
selecting a processing module based on the directive description portion of the third directive; and
providing an output signal from the processing module based on the directive description portion of the third directive.

19. The method of claim 15, wherein:
the user input includes aural signals and touch-generated signals;
the first data set represents a pattern based on the touch-generated signals; and
the second data set represents at least a portion of the aural signals.

20. The method of claim 15, wherein:
the user input includes motion signals associated with movement of the communications device; and
the first data set represents a first pattern of the movement signals, the second data set represents a second pattern of the movement signals different from the first pattern.
